(19) United States
(12) Patent Application Publication
(10) Pub. No.: US 2019/0164222 A1
(43) Pub. Date: May 30, 2019

(54) INTEGRATED BALANCED ORDER CROSSING MECHANISM

(71) Applicant: DEUTSCHE BÖRSE AG, Frankfurt (DE)

(72) Inventors: Thomas Winter, Frankfurt (DE); Fabian Rajlaarsdam, Frankfurt (DE); Andrei Jitariu, Frankfurt (DE)

(73) Assignee: DEUTSCHE BÖRSE AG, Frankfurt (DE)

(21) Appl. No.: 16/199,378

(22) Filed: Nov. 26, 2018

Related U.S. Application Data
(60) Provisional application No. 62/591,530, filed on Nov. 28, 2017.

(51) Int. Cl. G06Q 40/04

(52) U.S. Cl. CPC G06Q 40/04

(57) ABSTRACT

An order cross mechanism is provided where a cross request is received from a first market participant in a single transaction, the cross request specifying a client order and a predefined cross match type. Orders and/or quotes are received from second market participants within a predetermined or randomly determined period of time, and a cross match is performed in the order book immediately after expiration of the period of time. The client order is matched against an order of the first market participant and none, one or more of the orders or quotes received from the one or more second market participants, and the order of the first market participant is generated as an opposite order to the client order and having a higher priority than any orders or quotes received from the second market participants that are of the same price level than the order of the first market participant and that are entered during the period of time.

### BACKGROUND

Computer systems, methods of operating computer systems, and computer-readable storage media are provided, and in particular systems, methods and media that may be used for crossing orders in a financial market.

A cross of orders is defined as a match of a buy and a sell order entered by the same market participant with one order representing the client side. To achieve this, the market participant, often denoted as “broker”, has to enter the client order and an opposite order into the order book. This does however not take into account orders of other market participants that would also be available for the match. To achieve a cross of orders and at the same time consider other orders, it is necessary to make multiple transactions to the order book, which may result in a considerable amount of data traffic and require processing resources at the order book side and also at the market participant itself.

In addition, situations may exist where the client and broker side are represented by different market participants or by different traders of the same market participant. In both cases, the client and broker side of a cross request are entered separately and pre-arranged by the exchange on the trading platform within a pre-defined time interval. This leads to similar data traffic and processing resource requirements and therefore renders the technical implementation difficult.

A solution to reduce the amount of data traffic and processing resources would be desirable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A technique is provided that allows initiating a cross by a single transaction only, thereby reducing the amount of required data traffic and processing resources. Other market participants' orders or quotes can be considered by allowing these market participants to join the cross through submission of orders and quotes during a dedicated period of time. A further reduction of the required data traffic and processing resources is achieved by allowing the cross request to include a tolerable price, which may lead to cross match the client order against opposite orders at even more price levels and therefore may obviate multiple transmissions that are necessary in conventional systems to achieve a similar matching result.

In an embodiment, there is provided a computer system that comprises a memory and one or more processors. The memory stores executable instructions that, when being executed by the one or more processors, cause the one or more processors to receive a cross request from a first market participant in a single transaction. The cross request includes data specifying a client order and indicating a predefined cross match type. The cross request is a request to enter a cross event of the predefined cross match type into an order book and perform a cross match of the client order in accordance with the predefined cross match type. Orders and/or quotes are received from one or more second market participants different from the first market participant. The orders and/or quotes are received within a predetermined period of time. Further, the cross match is performed in accordance with the predefined cross match type in the order book immediately after expiration of the predetermined period of time. Performing the cross match in accordance with the predefined cross match type comprises matching the client order against an order of the first market participant and against other price-improving orders or quotes received from the one or more second market participants. The order of the first market participant is generated as an opposite order to the client order and has a higher priority than any orders or quotes received from the one or more second market participants within the predetermined period of time that are of the same price level than the order of the first market participant.

A cross announcement may be sent to the second market participants after having received the cross request. The predetermined period of time may start on or immediately after sending the cross announcement.

In an embodiment, the predetermined period of time may have a predefined or randomly defined time length.

The order of the first market participant may be generated to have an order priority time set to one of the time of sending the cross announcement or the start time of the predetermined period of time.

Performing the cross match in accordance with the predefined cross match type may further comprise matching the client order against one or more orders or quotes of arbitrary market participants having an order priority time earlier than the order priority time of the first market participant. The one or more orders or quotes of the arbitrary market participants may have a higher priority than the order of the first market participant.

In an embodiment, the cross request may further include data specifying a maximum tolerable price that is different from a price of the client order. More than one order of the first market participant may be generated, and each of the more than one order of the first market participant may have a price in a range given by the price of the client order and the maximum tolerable price. Each price of the more than one order of the first market participant may correspond to a price of one of the orders or quotes received from the one or more second market participants and entered during the predetermined period of time.

Each of the more than one order of the first market participant may be generated to have a quantity derived from one or more of the accumulated quantities of the orders and quotes having the same price received from the one or more second market participants and entered during the predetermined period of time, a maximum quantity percentage of the remaining client order quantity available for matching against the more than one order of the first market participant, and a minimum quantity percentage of the remaining client order quantity available for matching against the more than one order of the first market participant.

In an embodiment, performing the cross matching event in accordance with the predefined cross match type may be configured to consider the client order as the only order on the order book side of the client order.

There is also provided an embodiment of a method of operating a computer system to initiate a cross match in an order book. The method comprises receiving a client order and generating a cross request including data specifying the client order and data specifying attributes of an opposite order to the client order. The cross request is a request to trigger a cross matching event of a predefined cross match type to perform a match of the client order against the one or more orders of the first market participant or against other price-improving orders and/or quotes from one or more other market participants. The method further comprises performing a single transaction based on the generated cross request to cause the cross matching event of the client order against one or more orders of the first market participant and against one or more price improving orders and/or quotes from one or more other market participants.

The price-improving orders and/or quotes from the one or more other market participants may be orders and quotes entered into the order book during an announcement period after the single transaction took place.

The announcement period may have a predefined or randomly defined time length.

The opposite order may have an order priority time set to one of the time of performing the single transaction or the start time of the announcement period.

Performing the cross match in accordance with the predefined cross match type may comprise matching the client order against one or more orders or quotes of any market participants having an order priority time earlier than the order priority time of the opposite order.

The data specifying attributes of the opposite order may include data specifying a tolerable price that is different from a price of the client order thereby specifying a price range given by the price of the client order and the tolerable price.

The data specifying attributes of the opposite order may further include data specifying a method of how an opposite order's quantity is to be considered at the tolerable price.

The method of how the opposite orders quantity is to be considered at the tolerable price may be parameterized by one or more of a percentage parameter indicating the opposite order's quantity in proportion to accumulated quantities of the orders and quotes at a given price level and entered during the predefined period of time, a maximum quantity percentage of the remaining client order quantity at the given price level available for matching against the order book side of the broker order, and a minimum quantity percentage of the remaining client order quantity available for matching against the order book side of the broker order.

The predefined cross match type may be a type of cross match that considers the client order as the only order on the order book side.

In an embodiment, there is provided a tangible non-transitory computer-readable storage medium that stores a data structure holding an order book. The data structure comprises data indicating a cross event of a predefined cross match type for a client order received from a first market participant, and data specifying the client order. The data structure further comprises data specifying orders and/or quotes received from one or more second market participants different from the first market participant, where the orders and/or quotes are received within a predetermined period of time. The data structure further comprises data specifying an opposite order to the client order. The opposite order has a higher priority than any orders or quotes received from the one or more second market participants within the predetermined period of time that are of the same price level than the opposite order.

The data structure may further comprise computer-executable instructions to perform a cross match in accordance with the predefined cross match type immediately after expiration of the predetermined period of time. Performing the cross match in accordance with the predefined cross match type may comprise generating the data specifying the opposite order, and matching the client order against the opposite order and one or more of the orders or quotes received from the one or more second market participants.

The data structure may further comprise computer-executable instructions to send a cross announcement to the second market participants after having received a cross request that included data specifying the client order and indicating the predefined cross match type.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 is a block diagram illustrating a computing environment and its participants in accordance with an embodiment;

FIG. 2 is a flow chart illustrating a process and its phases according to an embodiment;

FIG. 3 is a flow diagram illustrating a process at the order book according to an embodiment;

FIG. 4 illustrates an example of a cross match in accordance with an embodiment where the client price is below the best bid-ask spread;

FIG. 5 illustrates an example of a cross match in accordance with an embodiment where the client price is at the best price level of the client side;

FIG. 6 illustrates an example of a cross match in accordance with an embodiment where the client price is inside the best bid-ask spread;

FIG. 7 illustrates an example of a cross match in accordance with an embodiment where the client price is at a new best price level of the broker side;

FIG. 8 illustrates an example of a cross match in accordance with an embodiment where the client price exceeds the new best price level of the broker side;

FIG. 9 illustrates an example of a cross match in accordance with an embodiment where the client price meets or exceeds the old best price level of the broker side;

FIG. 10 illustrates an example of a cross match in accordance with an embodiment where a tolerable price is used;

FIG. 11 illustrates another example of a cross match in accordance with an embodiment where a tolerable price is used;

FIG. 12 illustrates a complex example of a cross match in accordance with an embodiment where no tolerable price is used;

FIG. 13 illustrates the example of FIG. 12, now using a tolerable price, in accordance with an embodiment; and

FIG. 14 is a block diagram illustrating a technical implementation in accordance with an embodiment.

### DETAILED DESCRIPTION

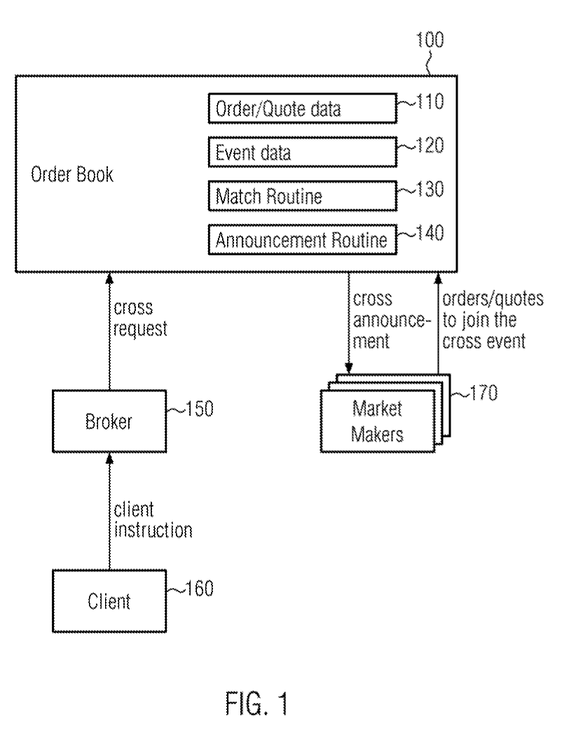

Referring to FIG. 1, the embodiments provide a new crossing functionality as a service to a broker 150 to facilitate the crossing of two opposing orders owned by himself/herself in the central order book 100 of the exchange. One of the orders is representing the client side. The new crossing functionality may ensure a guaranteed execution of a client order against the opposite side of the central order book 100 where the broker order is included at a price level provided by the broker 150. Potential price improvements resulting from the execution are given completely to the client side.

The new crossing functionality may be a service provided for cash or derivatives markets of an exchange, such as for the derivatives markets of Eurex by an electronic trading system such as the system T7. It is however noted that the embodiments are not restricted to derivatives markets but apply in general to all markets supporting an order book.

As mentioned above, a cross may be defined as a match of a buy and a sell order entered by the same market participant with one order representing the client side. In accordance with the new crossing functionality, a market participant 150 (denoted as “broker” in the following) who would like to perform a cross in a central order book 100 of an exchange specifies all information required for such a cross in one single transaction (cross request). In particular, the broker may specify the client side, the client quantity and client price. The broker 150 is taking over the opposite side having the same price and quantity (broker order).

There is provided a new matching type (denoted as cross match type in the following) applied to the order book 100 at the point in time when the cross is executed. The cross match type may guarantee the execution of the client order against the order book side of the broker order at the price level provided by the broker or even at a better price level from a client's point of view. The approach may explicitly consider the participation of additional orders on the broker side from market participants 170 different from the broker 150 (denoted as market maker in the following). Thus, an improvement of the client price is closely related to the price competition between broker and market makers. The price competition between broker 150 and market makers 170 may also be regarded as the most efficient method to achieve the best price for the client side which can be achieved via an order book. Thus, the approach of the embodiments may also be denoted as “best client order execution in the central order book of the exchange”.

Because of the price competition between broker and market maker for the benefit of the client 160, a balance of interest may be achieved in particular between broker 150 and market maker 170. The balance of interest and the protection of the client order may be achieved by the new crossing functionality and the use of a new matching type different from the already existing matching types.

The technique of the embodiments may be integrated into the order book 100. Accordingly, the order book 100 may include order/quote data 110, event data 120, one or more cross match routine 130 (i.e. computer-executable instruction to perform the cross matching functionality described), and one or more announcement routines 140 (i.e. computer-executable instructions to perform the cross announcements as described).

Process Description

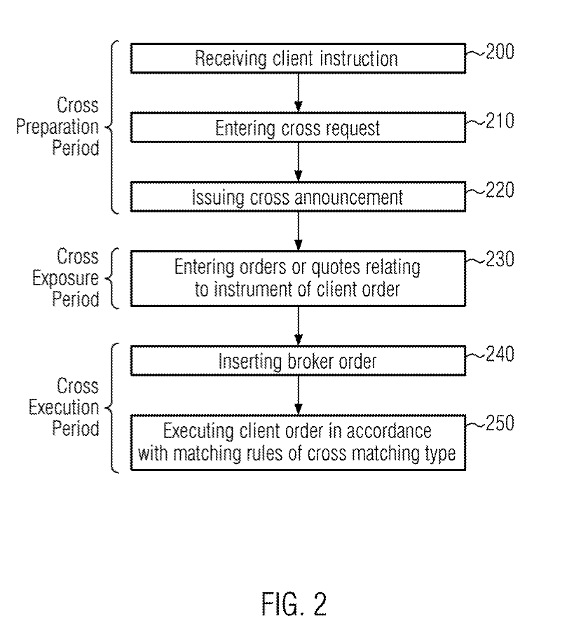

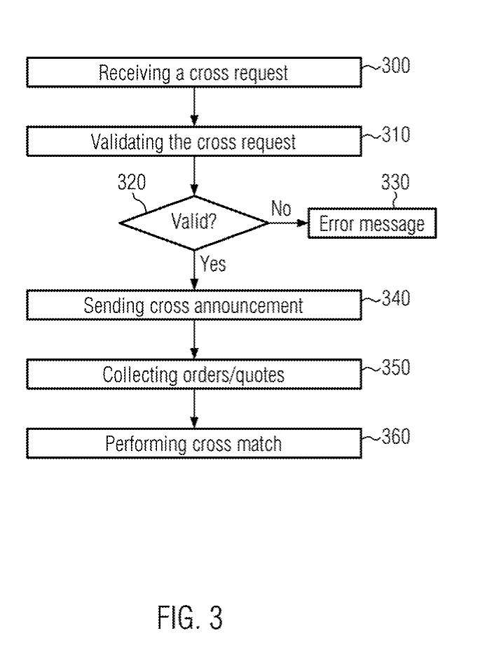

It is now referred to FIGS. 2 and 3, noting that FIG. 3 illustrates the process from the perspective of the order book 100. In an embodiment, the new crossing functionality may be divided into three different phases: (i) Cross Entry and Cross Announcement 200-220, 300-340, (ii) Cross Exposure Period 230, 350, and (iii) Cross Execution 240-250, 360.

In the first phase, a client order is received 200 from the client 160 and a cross request is entered 210, 300 into the order book by the broker 150 that may provide all information required to trigger a cross matching event in a single transaction. This information may include some or all of the following:
Instrument: Tradable object where the cross is taking place,
Client side: Buy or sell side of the client order,
Client quantity: preferably required to satisfy a minimum and/or maximum quantity threshold,
Client price: preferably being compliant with the best bid or ask price available in the corresponding order book at the point in time when the cross request is submitted; in case of a buy (sell) client order, the client price may be required to be strictly higher (lower) than the best bid (ask) in the order book,
Maximum tolerable broker price: a less favorable price from the broker point of view he/she is willing to be executed; the difference between client price and maximum tolerable broker price may be required to be compliant with a maximum tolerable broker price range provided by the exchange.

In case the cross request entry validations 310, 320 are successfully passed, the cross event may be publicly announced 220 to all market participants 170 (cross announcement). It may be determined by the exchange which additional information is provided with the cross announcement, i.e. whether the client side, the client quantity and/or the client price is included to the cross announcement or whether the submitting broker decides which information he/she would like to disclose in the cross announcement.

In case one of the cross request entry validations fails 320, the cross request may be rejected 330 by the exchange and a cross announcement may not occur.

In the second phase, the cross exposure period may start immediately after the cross announcement was published 340. The cross exposure period may provide the possibility to all market participants to join the cross event by submitting orders or quotes improving the client order price, and these orders and quotes are then entered 230, 350 into the order book.

During the cross exposure period, the matching rules valid during continuous trading and determined by the exchange for the corresponding product may still apply. Orders and quotes entered by the market makers may match against each other in accordance with the prevailing matching rules. Potential match events may not be related to the cross since the client and broker order remain inactive during the cross exposure period.

The cross exposure period may have a fixed or randomly defined time length specified by the exchange. This time length may be 1 second or even less (e.g. 100 milliseconds). Consequently, in an embodiment, market makers may make use of automated procedures to participate in a cross event.

In the third phase, the cross execution takes place, e.g. immediately after the cross exposure period is concluded. The corresponding point in time is denoted by t₁.

As part of the cross execution, first, the broker order may be passively inserted 240, 360 into the order book. The order priority time of the broker may be set to the time where the cross announcement took place and the cross exposure period starts. This time is denoted by t₀. Afterwards, the client order is executed 250 against the broker side in accordance with the matching rules which apply for the new cross match type listed below. As a consequence, the broker order either results in a complete, partial or even prevented execution against the client order.
Priority of Client Order: The only order considered on the order book side of the client order may be the client order itself. Consequently, additional orders including market orders or quotes on the client side may not be considered by the cross match.
Time Slicing Approach: Orders and quotes on the order book side of the broker order with an order priority time equal to or earlier than to may be considered first against the execution of the client order. In case of remaining client order quantity, the execution of the client order may continue at the same price level against the orders and quotes entered between t₀ and t₁ (i.e. entered during the cross exposure period). The time slicing approach may be independent of the allocation scheme (time, pro-rata or time-pro-rata) valid for the corresponding product and may ensure that the broker order is always considered with a higher priority than any order including market order or quote of the same price level entered between t₀ and t₁ (i.e. entered during the cross exposure period). The time slicing approach is a feature of the cross match type not known in conventional systems.

Synthetic Matching: If supported by the corresponding product and if available at time t₁, contributions resulting from synthetic order book combinations on the order book side of the broker order may be considered together with orders and quotes entered between t₀ and t₁.

In conventional systems, the broker and the market maker are competing for execution against the client order in the same way. However, the broker is restricted for pricing the overall client quantity of the intended cross while the market maker can freely choose a smaller quantity for which he can provide much more aggressive prices. Thus, the market maker can easily outpace the broker, and the broker therefore suffers a disadvantage. To compensate the broker for that disadvantage and to ensure a fair balance of interest between broker and market maker, a tolerable broker order concept is introduced in an embodiment.

The tolerable broker order may be based on a tolerable price range given by the client price and a maximum tolerable broker price specified by the broker when submitting the cross request. Each price level created by a market maker during the cross exposure period lying inside the tolerable price range may be considered as a valid tolerable broker price P_{tolBr}, and for each valid tolerable broker price, a tolerable broker order containing such a limit price may be automatically created.

The quantity of the tolerable broker order (denoted by Q_{tolBr}) may be derived by considering the accumulated quantity accQtyₜ_{₁}₋ₜ_{₀}(P_{tolBr}) provided by all market makers during the cross exposure period (i.e. entered between t₀ and t₁) and contributing to the valid tolerable price level P_{tolBr}. The tolerable broker order quantity may be given by a percentage (denoted as tolerable broker quantity percentage and abbreviated by tolBrQtyPcnt) of the accumulated quantity accQtyₜ_{₁}₋ₜ_{₀}(P_{tolBr}). Thus, the tolerable broker order quantity may be given by Q_{tolBr}=accQtyₜ_{₁}₋ₜ_{₀}(P_{tolBr})·tolBrQtyPcnt.

In case the tolerable broker order quantity Q_{tolBr} is exceeding a maximum quantity threshold, then the tolerable broker order quantity may be bounded to that threshold. The maximum threshold may be given as a percentage (denoted as maximum tolerable broker quantity percentage and abbreviated by tolQtyMaxPcnt) of the client order quantity available for matching against the broker side (remaining client order quantity at price level P_{tolBr}). Assume that the remaining client order quantity is denoted by Q_{Cl}^{rem}(P_{tolBr}), then the quantity threshold of a tolerable broker order may be given by Q_{tolBr}=Q_{Cl}^{rem}(P_{tolBr})·tolQtyMaxPcnt.

In case the tolerable broker order quantity Q_{tolBr} is below a minimum quantity threshold, then the tolerable broker order quantity Q_{tolBr} may be set to zero implying that there is no tolerable broker order created for the corresponding price level P_{tolBr}. The minimum threshold may be given as a percentage (denoted as minimum tolerable broker quantity percentage and abbreviated by tolQtyMinPcnt) of the client order quantity available for matching against the broker side (remaining client order quantity at price level P_{tolBr}). Thus, in case that Q_{tolBr} is smaller than Q_{Cl}^{rem}(P_{tolBr})·tolQtyMinPcnt, the tolerable broker order quantity may be set to zero, i.e. Q_{tolBr}=0.

The tolerable broker order and all other orders belonging to the same valid tolerable broker price P_{tolBr} may be executed on the price level P_{tolBr} in accordance with the matching rules which apply for the new cross match type mentioned above.

Functional Overview

As mentioned above, embodiments provide a particular match event in an order book where two orders of the same member, i.e. a client (agent) order and an opposing broker (proprietary) order of the same trader, are intended to be passively executed against each other. It is assumed that the client side is indicated by the trading capacity “agent”.

Each member can act as a broker 150 entering a cross request specifying attributes like “client side”, “client price” and “client quantity”. The entering broker 150 may always be on the opposite side of the client order with a broker price identical to the client price and a broker quantity identical to the client quantity.

The entering broker may specify other optional attributes such as maximum “tolerable broker price” which is a less favorable price from a broker point of view he/she is willing to be executed against the client order. Together with the tolerable broker price, the entering broker may specify the “broker quantity inclusion method”, i.e. a method how the broker quantity is considered at a tolerable broker price different from the client price. The broker quantity inclusion method may also be specified by the exchange leaving no choice for the broker entering the cross request. In case a maximum tolerable broker price is not specified upon entry, the client price may be the only price level at which the broker order can participate in the cross event.

The client order and the broker order information may be entered by one broker in one request considering the client and the broker order information by a two-sided cross request. As an alternative solution in an embodiment, the client and broker order information may be entered separately by a client broker and a proprietary broker representing the client and the broker side, respectively, by two different one-sided cross requests. The two different one-sided cross requests may be required to contain a unique cross reference allowing the identification and creation of a two-sided cross request by the trading platform. Additional validations may be applied with respect to the client price and client quantity and other attributes to ensure the consistency of the newly created two-sided cross request. The creation of a two-sided cross request may be performed within a maximum alignment period defined by the exchange. Any one-sided cross request which cannot be considered for the creation of a two-sided cross request within the maximum alignment period may be deleted by the trading platform after the lifetime a one-sided cross request exceeds the time of the maximum alignment period.

In an embodiment, a validation takes place where a cross request may be found to be valid only if
a. the client price is improving the market at the time of entry of the cross request,
b. the client quantity is equal to or larger than a minimum cross quantity and/or equal to or smaller than a maximum cross quantity, both specified by the exchange,
c. the tolerable price is compliant with the market at the time of entry of the cross request, and/or
d. the account information of the client side is indicating an agent business.

In case one of the mentioned criteria is not satisfied, the cross request may be rejected with an appropriate error message.

After a successful entry validation, the cross request may be publicly announced to all market participants by informing the market about an upcoming cross event. Optionally, and in an embodiment depending on the choice of the broker upon the entry of the cross request and the corresponding exchange configurations, the market participants may also be informed about the side, quantity and/or price of the client order.

After the announcement, the cross exposure period starts. Market participants 170 different from the entering broker 150 may be enabled to participate in the cross event by submitting orders or quotes. In particular, market makers already present in the order book of the corresponding instrument may be given the opportunity to improve their quotes. The prevailing matching rules for continuous trading valid in the corresponding product may apply during the exposure period, i.e. incoming orders or quotes may match in the order book of the corresponding instrument in accordance with the matching rule valid during continuous trading. However, the broker order and the client order may be held inactive and then do not participate in any matching event which may occur during the cross exposure period. The cross exposure period may be concluded after a fixed or randomly defined time duration.

Immediately after the cross exposure period is concluded, the cross matching may be performed as the only matching event considering the broker and client order. Depending on the order book situation after the cross exposure period, the cross event may comprise several price levels (matching steps). Cross matching principles, some or all of them being applicable in some embodiments, are summarized as follows.
a. The broker order may act as back-up for the matching of the client order in the order book of the corresponding instrument and may not match against other orders or quotes except against the client order.
b. The client order may be matched against the order book side of the broker order and may consider all potential price improvements on the order book side of the broker order which occurred during the cross exposure period.
c. The cross matching event may be starting with the best price level available on the broker side. This may also apply even in case the market improved the price of the client order during the cross exposure period. In case the quantity of the best price level on the broker side is completely matched against the client order and there is still client order quantity available, the matching of the client order may continue with the next best price level until the client order quantity is completely matched.
d. A cross matching event may consist of several cross match steps with a specific match price for each match step. Thus, in an embodiment, a cross matching event containing one match price may consist of one match step, and a cross matching event consisting of several match prices may have—at least—as many match steps as match price levels. For each cross match step, a time slicing approach may apply. The orders entered before the cross announcement including the broker order or the tolerable broker order may be considered first for the execution against the client order in agreement with the allocation scheme valid for the corresponding product. In case the matching of the client order can be continued at the same price level (which may occur for tolerable broker orders), the order book quantity which was entered after the announcement and the synthetic order book quantity contributions from other instruments of the same product may be considered afterwards in agreement with the allocation scheme and—if applicable—with the path priority valid for the corresponding product.

The time slicing approach may execute orders and quotes contributing to the same price level by preserving the already existing allocation scheme and—if applicable—the already existing path priority within a specific priority level.
e. In case the cross match step takes place at a price level different from the client price (i.e. better from a client point of view and worse from a broker point of view) and if
   the broker agreed to be executed up to a maximum tolerable price by providing a maximum tolerable broker price upon entry of the cross request,
   the price level of the match step considered for execution satisfies the condition of a tolerable broker price, and/or
   the price level of the match step contains orders entered after the cross announcement was made,
then an automatically created tolerable broker order may be considered in an embodiment for the price level of that match step. The quantity of the tolerable broker order may depend on the accumulated order quantity entered at the price level of that match step after the cross announcement was made in the corresponding instrument.
As a consequence of the outlined cross matching principles, it may be possible that the client order is executed against orders from a market maker but not against the order of the broker if a market maker improves the client price during the cross exposure period.
In case the broker order was not completely executed in a cross matching event, any remaining quantity of the broker order may be deleted afterward.
Thus, the cross event may be the only matching event where the client order and the broker order are considered. Any matching event taking place during continuous trading without the direct involvement of a cross request may not involve the client and broker order specified by a corresponding cross request.

Through the cross event outlined above, the client order may be completely executed against the order book side of the broker order. The client order may be matched at the client price provided by the broker or even at a better price from a client point of view. Potential price improvements by the market makers provided during the cross exposure period may result to a better client order match price. Consequently, there may be no execution guarantee for the broker order. Depending on the market situation after the cross exposure period, the broker order may be either completely, partially or not at all executed against the client order.

Thus, the client order may be executed at the best price level available on the order book side of the broker order justifying the expression “best client order execution in the central order book of the exchange”.

Cross Request

As mentioned above, a cross request may be prepared by a trader (denoted as broker). It may have some or all of the following attributes.
Instrument where the cross event takes place
Client side
Client side disclosure flag
Client price P_{Cl} denoted by P_{Cl}^{buy} in case of a buy or P_{Cl}^{sell} in case of a sell client order
Client price disclosure flag
Client quantity Q_{Cl}
Client quantity disclosure flag
Maximum tolerable broker price P_{MTol}, i.e. a less favorable price from a broker point of view he/she is willing to be executed against the client order; in case of a buy client order, the maximum tolerable sell broker price is denoted by P_{MinTol}^{sell}, and in case of a sell client order the maximum tolerable buy broker price is denoted by P_{MaxTol}^{buy}
   It is noted that the expression “maximum tolerable price” abbreviated by P_{MTol} is used regardless whether the broker is on the buy or sell side and, consequently, regardless whether the tolerable price entered by the broker must be larger or smaller than the client price P_{Cl}, i.e. whether the broker side is identical to the buy side or to the sell side. Thus, regardless whether the broker is on the buy or sell side, it is always the maximum “disadvantage” the broker is willing to accept when being considered at match price levels which is an improvement from the client point but a deterioration from the broker point of view.
Tolerable broker order quantity percentage tolBrOrderQtyPcnt, i.e. the quantity of the tolerable broker order may be determined in that way that a match of the tolerable broker order against the client order results to the specified quantity percentage of the matched client order quantity at a specific match price level

The order of the broker entering the request may be intended to be executed against the client order and may be opposite to the client side with the same price and the same quantity, i.e. P_{Br}^{sell}=P_{Cl}^{buy} in case of a buy client order and P_{Br}^{buy}=P_{Cl}^{sell} in case of a sell client order and Q_{Br}=Q_{Cl} for the broker order quantity. Both, the client and broker order information may be included to the same request to ensure that the client order can always be executed against the broker order to ensure a complete execution of the client order.

The entering broker may decide upon entry whether he/she intends to disclose the client side and/or the client quantity when the cross announcement is published to the market.

Entry Validation of Cross Request

In an embodiment, the processing of a cross request may only be possible during continuous trading. The cross request may satisfy zero, one or more of the following criteria:
Minimum and maximum quantity restriction: It may be validated that the client order quantity Q_{Cl} is equal to or higher than an exchange defined minimum quantity Q₀^{min} and/or equal to or less than an exchange defined maximum quantity Q₀^{max}, i.e. Q₀^{min}≤Q_{Cl}≤Q₀^{max}. The minimum and maximum quantity limits Q₀^{min} and Q₀^{max} may restrict a cross event to medium sized client order trades in the central order book which otherwise are difficult to be executed under normal circumstances. Consequently, the cross may also be interpreted to close the gap between small order book trades and large off-book trades. The validation also ensures the regulatory compliance of the cross.
Client Order may improve the market: It may be validated that in case of a client buy side, the client order buy price P_{Cl}^{buy} is strictly larger than the best bid price BPₜ_{₀} available at the point in time t₀ when the validation of the cross request is performed, i.e. BPₜ_{₀}<P_{Cl}^{buy}. In case of a client sell side, the client sell price P_{Cl}^{sell} may be restricted to be strictly smaller than the best ask price APₜ_{₀} available at the point in time t₀ when the validation of the cross request is performed, i.e. P_{Cl}^{sell}<APₜ_{₀}. It is to be noted that a client order may improve the market when the client price meets or exceeds the best price level of the opposite order book side, i.e. BPₜ_{₀}<APₜ_{₀}≤P_{Cl}^{buy} for a buy client order and P_{Cl}^{sell}≤BPₜ_{₀}<APₜ_{₀} for a sell client order. In this case, the entering broker may take into account that the client order is first executed against the best prices available in the market before the client order reaches the price level P_{Cl}^{buy} or P_{Cl}^{sell} of the buy or sell client order, respectively. Thus, when entering the cross request, the broker may already know that the client order will not be completely matched against the broker order.
Market Compliance of Tolerable Broker Prices: In case a tolerable broker price P_{MTol} is specified by the entering broker, it may be validated that the tolerable broker price P_{MTol} is compliant with the client price and compliant with the market situation at the point in time t₀ when the cross request was entered. In case of a buy client order, the minimum tolerable broker sell price P_{MinTol}^{sell} may be strictly smaller than the buy client price P_{Cl}^{buy} but strictly larger than the best bid price BPₜ_{₀}, i.e. BPₜ_{₀}<P_{MinTol}^{sell}<P_{Cl}^{buy}. In case of a sell client order, the maximum tolerable buy broker price P_{MaxTol}^{buy} may be strictly larger than the sell client price P_{Cl}^{sell} but strictly smaller than the best ask price APₜ_{₀}, i.e. P_{Cl}^{sell}<P_{MaxTol}^{buy}<APₜ_{₀}. Thus, the validation may provide a restriction to the maximum tolerable broker price in case of markets with small bid-ask spreads (i.e. in case of tight markets).
Maximum Tolerable Broker Price Range Validation: In case a maximum tolerable broker price is specified by the entering broker, it may be validated that the difference between the maximum tolerable broker price P_{MTol} and the client price P_{Cl} does not exceed a threshold which may be specified by a percentage value of the price range valid for the corresponding product and for the client price P_{Cl}, i.e. the following relation may be satisfied

|P_{MTol}−P_{Cl}|≤PrcRang(P_{Cl})·tolPrcRngPcnt
where PrcRng(P_{Cl}) represents the price range at the client price P_{Cl} valid for the corresponding product and the tolerable price range percentage tolPrcRangPcnt is a value provided by the exchange.
Tolerable broker order quantity percentage validation: In case a tolerable broker price is specified by the entering broker and the exchange allows the specification of a tolerable broker order quantity percentage by the entering broker, it may be validated that the tolerable broker order quantity percentage is inside a percentage range determined by the exchange.

In case one or more of the above mentioned criteria are not satisfied, the corresponding cross request may be rejected in an embodiment with an appropriate error message.

The cross request may optionally also be validated about the visibility of client side, client quantity and client price and their consistency regarding exchange settings.

Cross Announcement

After its successful validation, the cross request may be made public to some or all market participants to inform them about an upcoming cross matching event. Depending on the setting chosen by the exchange and by the entering broker upon entry, the announcement may include the client side, client quantity and/or the client price.

The publication time of the cross announcement may be assumed to be at t₀. It may be required in an embodiment to also disclose the time of the cross announcement to the market since the knowledge of the time of the cross announcement also enables the knowledge of the end of the cross exposure period at t₁.

Cross Exposure Period

The cross announcement may be taken as the trigger to start the cross exposure period. Its start time may be assumed to be identical to the time t₀ when the validation of the cross request is performed and when the cross is announced to the market participants.

The best bid and ask price describing the market situation at the end of the cross exposure period is denoted by BPₜ_{₁} and APₜ_{₁}, respectively. The best market price on the bid and ask side of the corresponding order book which was available at the start of the cross exposure period and which is still available after the end of the cross exposure period is denoted given by BPₜ_{₀}^{t}^{₁} and APₜ_{₀}^{t}^{₁}. Assuming that the market situation improved on the bid or ask side during the cross exposure period, then the relations BPₜ_{₀}^{t}^{₁}<BPₜ_{₁}, or APₜ_{₁}<APₜ_{₀}^{t}^{₁} are valid. Assuming that the market situation did not improve on the bid or ask side during the cross exposure period, then the equation BPₜ_{₀}^{t}^{₁}=BPₜ_{₁} or APₜ_{₁}=APₜ_{₀}^{t}^{₁} or both equation hold. In any case, taking into account the price information of the orders entered before the cross exposure period and still available after the cross exposure period, the market situation after the cross exposure period may be either unchanged or improved which can be expressed by the relation

BPₜ_{₀}^{t}^{₁}≤BPₜ_{₁}<APₜ_{₁}≤APₜ_{₀}^{t}^{₁},

In the following, the expression BPₜ_{₀} and APₜ_{₀} are used instead of BPₜ_{₀}^{t}^{₁} and BPₜ_{₀}^{t}^{₁} to denote the best bid and best ask price resulting from orders or quotes which were entered before the cross exposure period starts and which were still available after the cross exposure period ends. Thus, the last mentioned relation can be expressed by

BPₜ_{₀}≤BPₜ_{₁}<APₜ_{₁}≤APₜ_{₀}

Since the prevailing matching rules for continuous trading valid in the corresponding product may apply during the cross exposure period, incoming and executable orders or quotes may be immediately matched. Thus, it may be ensured that the relation BPₜ_{₁}<APₜ_{₁} holds at the end of the cross exposure period. The broker order and the client order may be inactive during the cross exposure period and may not participate in any matching event which may occur during the cross exposure period.

The exposure period may be concluded after a duration time Δt at t₁=t₀+Δt with Δt being either fixed or randomly defined. It may be assumed in an embodiment that the duration time Δt of the cross exposure period is in the order of one second or even less. The fixed duration time may be regarded as an advantage with respect to the market makers since they are able to provide more competitive quote only for a short period of time at the end of the cross exposure period.

Cross Matching Rules

The cross event may be performed immediately after the cross exposure period is concluded which is assumed to be at time t₁. Market participants may be able to deduce the cross event time t₁ once they receive the cross announcement at time t₀ because of the fixed duration time Δt of the cross exposure period.

The cross event may be the only matching event where the broker order and the client order specified in a cross request are considered for execution. In an embodiment, both, the client and the broker order may not be considered for any other matching before or after the cross event.

In the following, a consistent set of cross matching rules are described, with arbitrary combinations of zero or more of these cross matching rules being used in embodiments.

A first cross matching rule deals with liquidity providing versus taking sides. The broker side of the order book may be regarded as the liquidity providing side of the cross matching event. The broker order may be treated as a passive order with an order priority time t₀ but considered in the order book after the client order exposure time t₁>t₀. In the cross matching event, the client order is the only order considered at the liquidity taking side and may be matched against the liquidity providing side regardless of the market development during the cross exposure period. Thus, the client side of the cross request may be regarded as the liquidity taking side.

The first cross matching rule determines the broker (client) side as liquidity providing (taking) side regardless of the development of the market during the cross exposure period. There may be a specific market situation which is consistently resolved by the cross matching rules but which is perceived as a match outside the prevailing best bid-ask spread compared to the general matching rules valid in continuous trading. Therefore, it may be required to define a new set of matching rules explicitly valid for a cross event with specific priorities for the client and broker order.

A second cross matching rule deals with price-level based matching. The matching of the client order may start with the best available price level on the broker side. In case the quantity of the best price level on the broker side is completely matched against the client order and there is still client order quantity available, the matching may continue with the next best price level on the broker side. Since the broker order is the natural counter part of the client order with respect to price and quantity, the price level based matching may end latest at the client order price P_{Cl}.

The second cross matching rule may represent the usual price priority valid for the general matching rules in continuous trading.

A third cross matching rule deals with a price level specific time slicing approach. The matching of the client order at a specific price level may take into account first all orders and quotes on the order book side of the broker order including the broker order which were entered before the cross announcement in the corresponding instrument, i.e. entered before time t₀. All orders and quotes of this first time slice may be considered in accordance with the prevailing allocation scheme (such as time allocation, time-pro-rata allocation and pro-rata allocation) valid for the corresponding product. In case of any remaining quantity of the client order (which may occur if the broker order does not join the corresponding price level with its full quantity Q_{Br}), the client order execution may be continued on the same price level against all orders on the order book side of the broker order which were entered after the cross announcement, i.e. entered after time t₀, and—if applicable—against all quantity contributions resulting from synthetic paths. All orders of this second time slice may be considered in accordance with—if applicable—the prevailing path priority (such as “direct” path first, “synthetic” path of length 2 first, “pro-rata” share of direct and all synthetic paths of length 2 at best price level) and with the prevailing allocation scheme valid for the corresponding product.

The time slicing approach introduced by the third cross matching rule may result to the following sub-price level priorities of orders and quotes contributing to the same price level.
First Time Slice:
   Priority (1): Market orders entered before t₀ with overall accumulated quantity of accQₘₖₜ^{<t}^{₀}
   Priority (2): Limit orders entered before t₀ with overall accumulated quantity of accQₗᵢₘ^{<t}^{₀}
   Priority (3): Broker order entered at t₀ with quantity of Q_{Br} or tolerable broker order entered at t₀ with quantity of Q_{tolBr}<Q_{Br}
Second Time Slice:
   Priority (4): Market orders entered between t₀ and t₁ with overall accumulated quantity of accQₘₖₜ^{t}^{₁}^{-t}^{₀} to
   Priority (5): Limit orders entered between t₀ and t₁ with overall accumulated quantity of accQₗᵢₘ^{t}^{₁}^{-t}^{₀} and—if it applies—all synthetic quantity contributions in the corresponding instrument independent from its creation time with overall quantity of accQ_{syn}^{<t}^{₁}; in the following, quantity contributions from limit orders entered after t₀ and synthetic quantity contributions are summarized by accQₗᵢₘ^{<t}^{₁}=accQₗᵢₘ^{t}^{₁}^{-t}^{₀}+accQ_{syn}^{<t}^{₁}.

As a consequence of the time slicing approach, limit orders entered before to may be matching with a higher priority than market orders entered after t₀.

The third cross matching rule may ensure that the client order is executed at a specified price level in the sequence of the sub-price priorities defined above. Consequently, a sub-price priority level with its accumulated quantity may be completely executed first against the client order before the next sub-price priority level is taken into account.

If the remaining client order quantity is less than the accumulated quantity of the corresponding sub-price priority level, then the remaining client order quantity may be allocated to the book orders of the corresponding priority level in accordance with the prevailing allocation scheme valid for the corresponding product. In case of a product supporting synthetic matching and the sub-price priority level (5) is involved, the remaining client order quantity may be allocated to the direct and synthetic order book paths in accordance with the prevailing path priority and, afterwards, in accordance with the prevailing order book allocation scheme valid for the corresponding product.

As an example, in case the accumulated quantities of sub-price priority levels (1) to (3) are already executed against the client order and the remaining client order Q_{Cl}^{rem} is less than the accumulated quantities of the next sub-price priority level (4), which contains all market orders accQₘₖₜ^{t}^{₁}^{-t}^{₀} to entered after t₀, i.e. Q_{Cl}^{rem}<accQₘₖₜ^{t}^{₁}^{-t}^{₀}, then the remaining client order may be allocated to these market orders based on the allocation scheme valid for the corresponding product.

A fourth cross matching rule deals with the involvement of market orders on the liquidity providing side, i.e. on the side of the broker order. Independent from their entry time, market orders may be considered only in the cross matching event if they are on the same side of the broker order and if the price level considered for the cross matching event is generated by limit orders or quotes different from the broker order. Market orders on the liquidity taking side, i.e. on the side of the client order, may not be considered since according to the first cross matching rule, the client order is the only order considered on the liquidity taking side implying the exclusion of market orders on the liquidity taking side in a cross matching event.

Compared to the general matching rules in continuous trading, the first and fourth cross matching rule may prevent the matching of market orders in the cross matching event at the expense of the client or broker order. Thus, the restriction of market order matching in a cross matching event may be required to protect the execution of the client order against the broker order.

### Examples

In the following, the market development during the cross exposure period is outlined and divided into several different cases. Each case describes a potential market situation which can occur at the end of the cross exposure period at t₁. The impact of the cross matching rules is discussed in detail for each case.

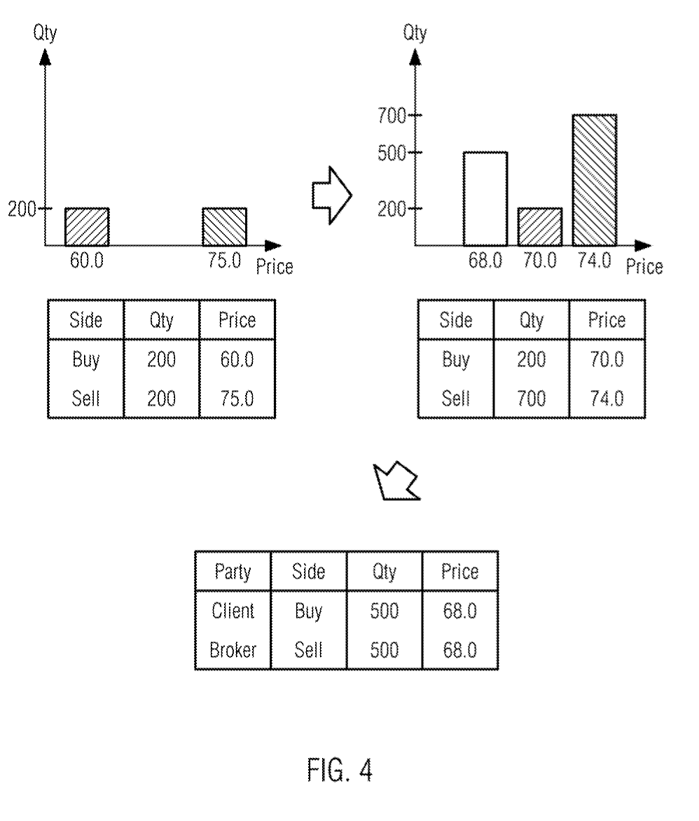

Referring to FIG. 4, a case is described where the client price is below the best bid-ask spread. In the following, it is assumed that the market moved against the client order during the cross exposure period. Thus, after the end of the cross exposure period at t₁, the client price is worse than the best price level on the client side. Consequently, the client order does not improve anymore the market. Such a market situation can be expressed by the following relation.

BPₜ_{₀}<P_{Cl}^{buy}<BPₜ_{₁}<APₜ_{₁}≤APₜ_{₀} for a buy client order

BPₜ_{₀}≤BPₜ_{₁}<APₜ_{₁}<P_{Cl}^{sell}<APₜ_{₀} for a sell client order

In accordance with the first cross matching rule, the client order is matched against the best price level on the order book side of the broker order although there are additional orders on the client side having a higher (better) price priority. However, the best price level on the order book side of the broker order is identical to the price P_{Br} of the broker order itself. But the broker price P_{Br} is already crossing the best price level on the order book side of the client order. Since P_{Br}=P_{Cl} and in accordance with the second cross matching rule, the cross match price MP is identical to the client price P_{Cl}, i.e. MP=P_{Cl}<BPₜ_{₁} for a buy client order and MP=P_{Cl}>APₜ_{₁} for a sell client order.

The client order is completely matched against the broker order, i.e. it is a 1:1 match with a matched quantity MQ identical to the broker order quantity Q_{Br}, i.e. MQ=Q_{Br}.

No other orders are involved in the cross match. In particular, market orders need not to be considered because of the first and fourth cross matching rule.

Compared to standard matching rules, the cross match performed at t₁ occurred outside of the prevailing best bid-ask spread, i.e. outside the price interval [BPₜ_{₁},APₜ_{₁}] valid at t₁ (the time of the cross matching event) but strictly inside the price interval [BPₜ_{₀},AP₀] valid at to (the time of the cross announcement). To overcome this situation, an additional flag in the market data interface is indicating that a match step results to a match price outside the bid-ask spread valid at the point in time when the match step was performed at t₁. Thus, for consistency reasons, the order priority time of the client order must be identical to t₁, and the publication sequence of market data is as follows:
1) cross announcement at t₀,
2) Market improvement of the best price level on the client order side during the cross exposure period between t₀ and t₁ (which is exceeding the client order price P_{Cl}),
3) cross matching event performed at time t₁ with an execution time stamp of t₁ and with a match price indication outside the valid best bid-ask spread.

Taking the publication sequence into account, market participants are able to realize that the market moved against the client order.

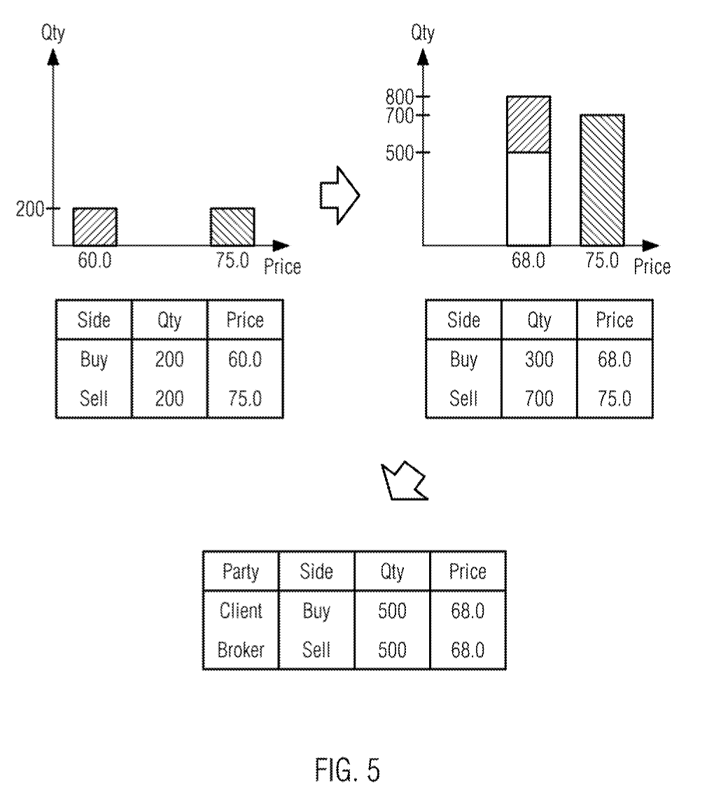

FIG. 5 illustrates a case where the client price is at the best price level of the client side. In the following, it is assumed that the market moved against the client order during the cross exposure period. The client price is now identical to the best price level of the client order side. As a consequence, the client order does still not improve anymore the market. Such a market situation can be expressed by the relation

BPₜ_{₀}≤BPₜ_{₁}=P_{Cl}^{buy}<APₜ_{₁}≤APₜ_{₀} for a buy client order

BPₜ_{₀}≤BPₜ_{₁}=P_{Cl}^{sell}=APₜ_{₁}≤APₜ_{₀} for a sell client order

In accordance with the first cross matching rule, the client order is matched against the best price level on the order book side of the broker order. Since the price of the broker order P_{Br} is now identical to the best price level of the client order side which is also identical to the client price P_{Cl}, this best price level is equal to BPₜ_{₁} in case of a buy client order and equal to APₜ_{₁} in case of a sell client order. In accordance with the second cross matching rule, the cross match price MP is identical to the best price level on the client order side, i.e. MP=P_{Cl}=BPₜ_{₁} for a buy client order and MP=P_{Cl}=APₜ_{₁} for a sell client order.

The client order is completely matched against the broker order, i.e. it is a 1:1 match with a matched quantity MQ identical to the broker order quantity Q_{Br}, i.e. MQ=Q_{Br}.

No other orders are involved in the cross match. In particular, market orders need not to be considered because of the first and fourth cross matching rule.

In accordance with the first cross matching rule, the client order is matched against the best price level on the order book side of the broker order although there are additional orders on the client side having the same price.

Thus, a market maker joining the best price level on the client side during the cross exposure period between t₀ and t₁ is not considered in the cross matching event. As a consequence, the publication sequence of market data is as in the case of FIG. 4:
1) cross announcement at t₀,
2) Market improvement of the best price level on the client order side during the cross exposure period between t₀ and t₁ (which is now identical to the client order price P_{Cl}),
3) cross matching event performed at time t₁ with an execution time stamp of t₁.

Taking the publication sequence into account, again, market participants are able to realize that the market moved against the client order.

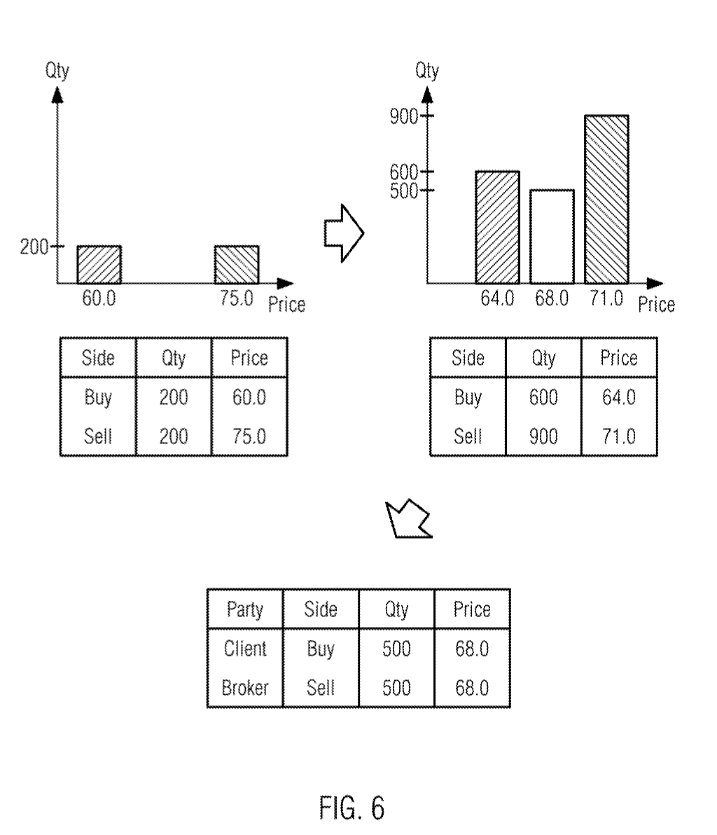

Referring now to FIG. 6, a case is shown where the client Price is inside the best bid-ask spread. In the following, it is assumed that the price of the client order P_{Cl} is strictly inside the best bid-ask price interval, i.e. inside the price interval]BPₜ_{₁},APₜ_{₁}[, valid at t₁. Such a market situation can be expressed by the relation

BPₜ_{₀}≤BPₜ_{₁}<P_{Cl}^{buy}<APₜ_{₁}≤APₜ_{₀} for a buy client order

BPₜ_{₀}≤BPₜ_{₁}<P_{Cl}^{sell}<APₜ_{₁}≤APₜ_{₀} for a sell client order

Since the broker order with price P_{Br}=P_{Cl} defines the best price level on the order book side of the broker order, the cross match price MP is identical to the client price, i.e. MP=P_{Cl}, which is in line with the first and second cross matching rules. Because of the first and fourth cross matching rule, market orders need not to be considered. The cross match price is strictly inside the prevailing best bid-ask spread, i.e. BPₜ_{₁}<MP<APₜ_{₁}.

The client order is completely matched against the broker order, i.e. it is a 1:1 match with a matched quantity MQ identical to the broker order quantity Q_{Br}, i.e. MQ=Q_{Br}.

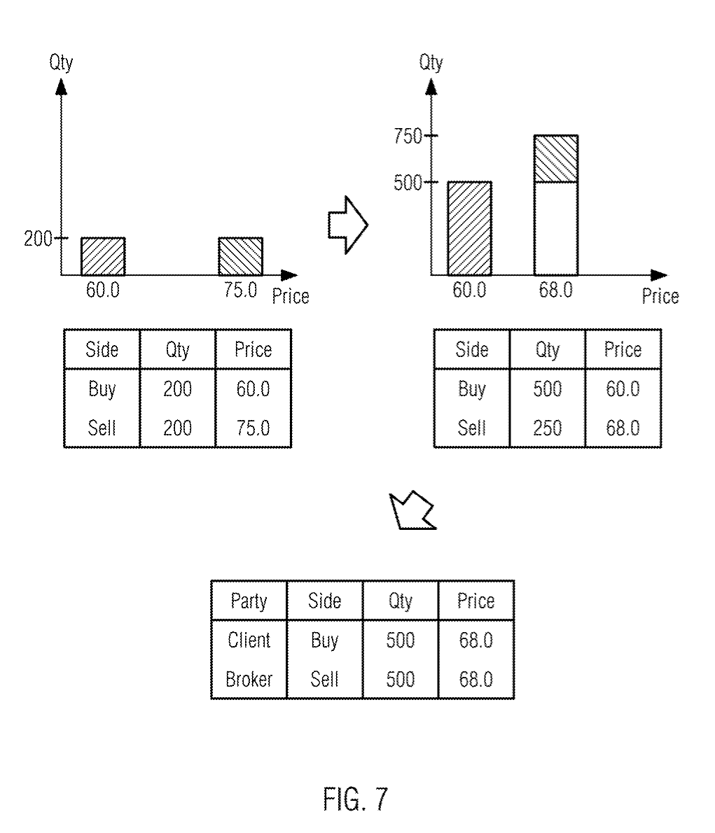

FIG. 7 depicts a case with a client price at a new best price level of the broker side. In the following, it is assumed that the price of the client order P_{Cl} was below the best price level of the broker side before the cross announcement at time t₀ and now meets the improved best price level of the broker side at time t₁. Such a market situation can be expressed by the relation

BPₜ_{₀}≤BPₜ_{₁}<APₜ_{₁}=P_{Cl}^{buy}≤APₜ_{₀} for a buy client order

BPₜ_{₀}≤P_{Cl}^{sell}=BPₜ_{₁}<APₜ_{₁}≤APₜ_{₀} for a sell client order

The best price level on the broker side is again identical to the price of the broker order P_{Br}=P_{Cl} but the price level contains additional book limit orders. Thus, in accordance with the first and second cross matching rules, the cross match price MP is identical to the broker or client price, i.e. MP=P_{Cl}=APₜ_{₁} for a buy client order and MP=P_{Cl}=BPₜ_{₁} for a sell client order.

Book limit orders on the broker side contributing additional quantity to the match price level at MP=P_{Cl} are potentially entered before and after t₀. If there are market orders on the broker side, then they need to be considered in accordance with the fourth cross matching rule. Thus, in accordance with the third cross matching rule, the following accumulated quantity contributions need to be considered at match price level MP=P_{Cl} in the sequence mentioned below.
1) Accumulated market order quantity entered before t₀, i.e. accQₘₖₜ^{<t}^{₀}
2) Accumulated limit order quantity entered before t₀, i.e. accQₗᵢₘ^{<t}^{₀}
3) Full broker order quantity, i.e. Q_{Br}=Q_{Cl}
4) Accumulated market order quantity entered after t₀, i.e. accQₘₖₜ^{t}^{₁}^{-t}^{₀}
5) Accumulated limit order quantity entered after t₀, i.e. accQₗᵢₘ^{<t}^{₁}

Since the quantity of the broker order is identical to the quantity of the client order, the accumulated market and limit order quantity entered after t₀ is not participating in the cross match. The participation of the broker order in the cross match depends on the accumulated market order quantity accQₘₖₜ^{<t}^{₀}+accQₗᵢₘ^{t}^{₀} entered before t₀. In case that the accumulated order quantity before t₀ exceeds the broker order quantity, i.e. accQₘₖₜ^{<t}^{₀}+accQₗᵢₘ^{<t}^{₀}≥Q_{Cl}, then the broker order is not involved in the cross match. In case that the accumulated market order quantity is smaller than the broker order quantity, i.e. accQₘₖₜ^{<t}^{₀}+accQₗᵢₘ^{<t}^{₀}<Q_{Cl}, then the broker order is partially matched. The broker order is completely matched against the client order, if there are no orders on the broker side entered before t₀, i.e. accQₘₖₜ^{<t}^{₀}+accQₗᵢₘ^{<t}^{₀}=0.

Thus, the client order is completely matched at price level MP=P_{Cl} in a 1:n match, and the broker order is either completely (n=1), partially (n>1) or not at all (n≥1) participating in the cross match. Since there is only one cross match price, the cross match event consist of one match step.

Although the time slicing approach provides an advantage for the broker order, a partial or no execution of the broker order cannot be excluded for the market situation of this case.

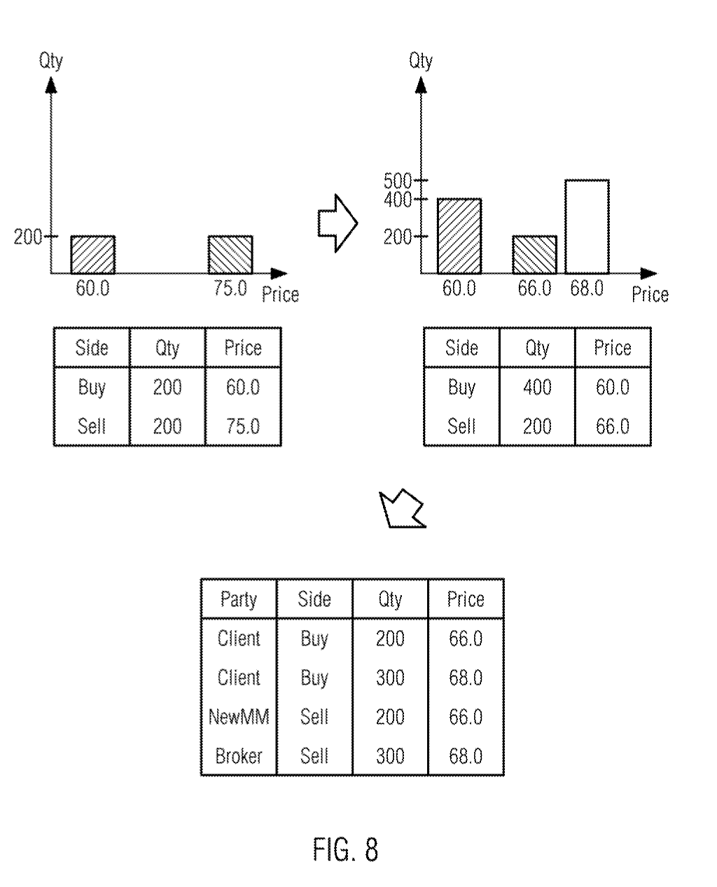

FIG. 8 illustrates a case where the client price exceeds the new best price level of the broker side. In the following, it is assumed that the price of the client order P_{Cl} was below the best price level of the broker side before the cross announcement at time t₀ and now exceeds the improved best price level of the broker side at time t₁. Such a market situation can be expressed by the relation

BPₜ_{₀}≤BPₜ_{₁}<APₜ_{₁}<P_{Cl}^{buy}≤APₜ_{₀} for a buy client order

BPₜ_{₀}≤P_{Cl}^{sell}<BPₜ_{₁}<APₜ_{₁}≤APₜ_{₀} for a sell client order

The best price level on the broker side is not identical to the price of the broker order P_{Br}=P_{Cl} since the broker price was improved during the cross exposure period between t₀ and t₁. In accordance with the first and second cross matching rules, the cross match price results in a price improvement from a client point of view, i.e. MP=APₜ_{₁}<P_{Br}^{sell}=P_{Cl}^{buy} for a buy client order and MP=BP₁>P_{Br}^{buy}=P_{Cl}^{sell} for a sell client order.

All book limit orders on the broker side contributing to the match price level at MP are entered after t₀. If there are market orders on the broker side, then they need to be considered in accordance with the fourth cross matching rule. In accordance with the third cross matching rule, the following accumulated quantity contributions need to be considered at match price level MP in the sequence mentioned below.
1) Accumulated market order quantity entered before t₀, i.e. accQₘₖₜ^{<t}^{₀}
2) Accumulated market order quantity entered after t₀, i.e. accQₘₖₜ^{t}^{₁}^{-t}^{₀}
3) Accumulated limit order quantity entered after t₀, i.e. accQₗᵢₘ^{<t}^{₁}

Since the broker order does not contribute to the match price MP, the first cross match step is performed without the participation of the broker order.

In case the quantity contributions to the first cross match step are identical to or exceed the client quantity Q_{Cl}, i.e. accQₘₖₜ^{<t}^{₀}+accQₘₖₜ^{t}^{₁}^{-t}^{₀}+accQₗᵢₘ^{<t}^{₁}≥Q_{Cl}, then the cross match event consists of one match step with one match price MP. The broker order is not at all involved to the whole cross matching event.

In case the quantity contributions to the first cross match step are smaller than the client quantity Q_{Cl}, i.e. accQₘₖₜ^{<t}^{₀}+accQₘₖₜ^{t}^{₁}^{-t}^{₀}+accQₗᵢₘ^{<t}^{₁}<Q_{Cl}, then there is a remaining client order quantity Q_{Cl}^{rem}>0 after the best price level was completely matched. In accordance with the second cross matching rule, the next best price level in the order book of the broker side is considered by a next cross match step with a reduced client order quantity of Q_{Cl}^{rem}. If the price of the broker order is not identical to the match price of the new cross match step, then the market situation described by FIG. 8 is still valid and the corresponding procedure valid for FIG. 8 is executed again. If the price of the broker order is identical to the match price of the new cross match step, then the market situation is identical to the FIG. 7 and the procedure valid for FIG. 7 applies.

The cross matching event is concluded either when the client order quantity is completely consumed after several different cross match steps or when the price level of the client order P_{Cl} originally provided by the broker is reached by the last cross match step.

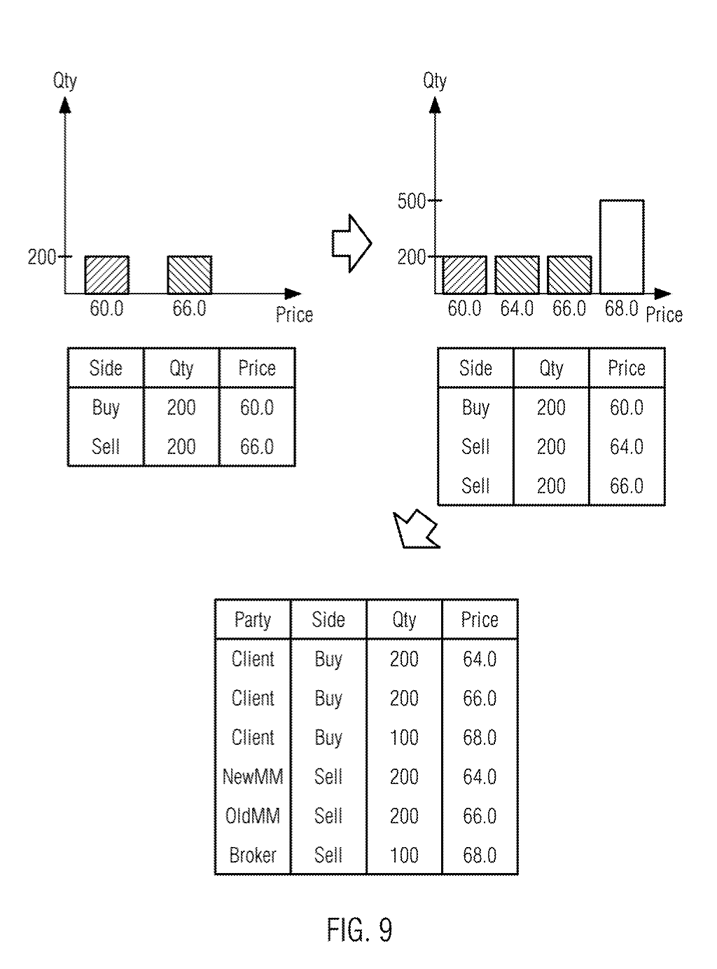

FIG. 9 relates to a case where the client price meets or exceeds the old best price level of the broker side. In the following, it is assumed that the price of the client order P_{Cl} is equal to or exceeds the best price level of the broker side available before the cross announcement at time t₀ and the best price level of the broker side was improved during the cross exposure period. Such a market situation can be expressed by the relation

BPₜ_{₀}≤BPₜ_{₁}<APₜ_{₁}≤APₜ_{₀}≤P_{Cl}^{buy} for a buy client order

P_{Cl}^{sell}≤BPₜ_{₀}≤BPₜ_{₁}<APₜ_{₁}≤APₜ_{₀} for a sell client order

Since the market situation APₜ_{₁}=APₜ_{₀}=P_{Cl}^{buy} for a buy client order and P_{Cl}^{sell}=BPₜ_{₀}=BPₜ_{₁} for a sell client order is already covered by FIG. 7, FIG. 9 assumes that the best price level on the broker side of the order book does not include the broker order.

Thus, the best price level on the broker side is not identical to the price of the broker order P_{Br}=P_{Cl} since the broker price was already worse than the best price level available before the cross announcement at time t₀. In accordance with the first and second cross matching rules, the cross match price of the first match step MP₁ results in a price improvement from a client point of view, i.e. either

MP₁=APₜ_{₁}<APₜ_{₀}≤P_{Br}^{sell}=P_{Cl}^{buy} or

MP₁=APₜ_{₁}≤APₜ_{₀}<P_{Br}^{sell}=P_{Cl}^{buy} or

MP₁=APₜ_{₁}<APₜ_{₀}<P_{Br}^{sell}=P_{Cl}^{buy}

for a buy client order and

MP₁=BPₜ_{₁}>BPₜ_{₀}≥P_{Br}^{buy}=P_{Cl}^{sell} or

MP₁=BPₜ_{₁}≥BPₜ_{₀}>P_{Br}^{buy}=P_{Cl}^{sell} or

MP₁=BPₜ_{₁}>BPₜ_{₀}>P_{Br}^{buy}=P_{Cl}^{sell}

for a sell client order. The first match step needs to consider the quantity contributions
1) Accumulated market order quantity entered before t₀, i.e. accQₘₖₜ^{<t}^{₀}
2) Accumulated limit order quantity entered before t₀, i.e. accQₗᵢₘ^{<t}^{₀}
3) Accumulated market order quantity entered after t₀, i.e. accQₘₖₜ^{t}^{₁}^{-t}^{₀}
4) Accumulated limit order quantity entered after t₀, i.e. accQₗᵢₘ^{<t}^{₁}

A second match step is only required if the accumulated order quantities do not exceed the client quantity Q_{Cl}, i.e. if the relation

accQₘₖₜ^{<t}^{₀}+accQₗᵢₘ^{<t}^{₀}+accQₘₖₜ^{t}^{₁}^{-t}^{₀}+accQₗᵢₘ^{<t}^{₁}<Q_{Cl}

holds. Thus, the broker order can only be matched partially in the cross matching event but a full broker order match is not possible.

In case the accumulated order quantities of the first match step are lower than the client quantity Q_{Cl}, then the remaining client quantity Q_{Cl}^{rem}>0 is available for a second match step at the next best price level on the order book side of the broker order indicated by a match step price MP₂. Potential order book contributions on the broker side are
1) Accumulated limit order quantity entered before t₀, i.e. accQₗᵢₘ^{<t}^{₀}
2) Full broker order quantity, i.e. Q_{Br}=Q_{Cl}
3) Accumulated limit order quantity entered after t₀, i.e. accQₗᵢₘ^{<t}^{₁}

In case the broker price is not identical to the match step price MP₂, then only the accumulated limit order quantities entered before and after t₀ need to be considered on the broker side.

The cross matching event is concluded either when the client order quantity is completely consumed after a cross match steps was performed or when the price level of the client order P_{Cl} originally provided by the broker is reached by the last cross match step.

Tolerable Order

From an exchange point of view, the cross service of the embodiments may aim to motivate a broker to execute medium sized client trades in the central order book. The introduction of a minimum and maximum cross quantity limit Q₀^{min} and Q₀^{max}—the client quantity Q_{Cl} may be compliant with the minimum and maximum cross quantity limit, i.e. Q₀^{min}≤Q_{Cl}≤Q₀^{max}—is emphasising the motivation. On the other hand, market makers are able to quote any quantity level and, consequently, may provide much more aggressive prices for smaller quantities. To balance the different motivation of broker and market makers, the cross service may allow the automatic creation of tolerable broker orders to join a price level improved by a market maker with a fraction of the original client quantity.

The tolerable broker order may be only relevant for market situations where the client order receives a price advantage, i.e. for market situations of FIG. 8 and for market situations of FIG. 9. For all other market situations discussed above, the cross matching event may result to only one cross match price MP which may be identical to the client price P_{Cl} originally provided by the broker, i.e. MP=P_{Cl}. Consequently, the tolerable broker order may be obsolete in these market situations.

When entering a cross request, the entering broker may specify a maximum tolerable broker price P_{MTol} in an embodiment. As already mentioned, the tolerable broker price P_{MTol} may be a less favorable price from a broker point of view he/she is willing to be executed against the client order.
In case of a buy client order, the maximum tolerable sell broker price P_{MinTol}^{sell} may provide a lower limit up to which the broker is willing to act on the sell side against the buy client order, i.e. P_{MinTol}^{sell}<P_{Br}^{sell}=P_{Cl}^{buy}. This may imply that the broker is willing to receive a lower price up to the price level of P_{MinTol}^{sell} when he/she is selling against the client order.
In case of a sell client order, the maximum tolerable buy broker price P_{MinTol}^{buy} may provide an upper limit up to which the broker is willing to act on the buy side against the sell client order, i.e. P_{MinTol}^{buy}>P_{Br}^{buy}=P_{Cl}^{sell}. This may imply that the broker is willing to pay a higher price up to the price level of P_{MinTol}^{buy} when he/she is selling against the client order.

Any price level between the maximum tolerable broker price P_{MinTol}^{sell} or P_{MaxTol}^{buy} and the client price P_{Cl}^{buy}=P_{Br}^{sell} or P_{Cl}^{sell}=P_{Br}^{buy}, respectively, may be a valid tolerable broker price P_{tolBr} which may be used to generate a tolerable broker order.

Thus, for a buy client order, a tolerable sell broker prices P_{tolBr}^{sell} may satisfy the relation

P_{MinTol}^{sell}≤P_{tolBr}^{sell}<P_{Br}^{sell}=P_{Cl}^{buy}

For a sell client order, a tolerable buy broker prices P_{tolBr}^{buy} may satisfy the relation

P_{Cl}^{sell}≤P_{Br}^{buy}<P_{tolBr}^{buy}≤P_{MaxTol}^{buy}

The above mentioned relation for a buy and sell client order may specify the valid tolerable broker prices.

In accordance with market situations described in FIGS. 8 and 9, assume that there are several potential cross match price levels on the broker side different from the original client price and available for execution against the client side.

The number of potential match price levels is denoted by no, and MP⁽ⁿ⁾≠P_{Cl} for each n=1, . . . , n₀ indicates that each match price level (i.e. each match step) is different from the original client price P_{Cl}=P_{Br}.

As general rule for the creation of tolerable broker orders, only match price levels MP⁽ⁿ⁾, n=1, . . . , n₀ on the broker side
satisfying the condition of a valid tolerable broker price, i.e. for a buy client order the following relation holds

P_{MinTol}^{sell}≤MP⁽ⁿ⁾<P_{Br}^{sell}=P_{Cl}^{buy} with MP⁽ⁿ⁾=P_{tolBr}^{sell}

and for a sell client order the following relation holds

P_{Cl}^{sell}=P_{Br}^{buy}<MP⁽ⁿ⁾≤P_{MaxTol}^{buy} with MP⁽ⁿ⁾=P_{tolBr}^{buy}
containing accumulated quantity entered after the cross announcement at t₀, i.e. match price levels with accQₘₖₜ^{t}^{₁}^{-t}^{₀} to +accQₗᵢₘ^{t}^{₁}^{-t}^{₀}>0 may be considered for the creation of a tolerable broker order in an embodiment.

Thus, the match price levels only containing accumulated quantities entered before the cross announcement, i.e. accQₘₖₜ^{<t}^{₀}+accQₗᵢₘ^{<t}^{₀}>0 but accQₘₖₜ^{t}^{₁}^{-t}^{₀}+accQₗᵢₘ^{t}^{₁}^{-t}^{₀}=0, may not be considered for the creation of a tolerable broker order. The accumulated limit order quantity accQₘₖₜ^{t}^{₁}^{-t}^{₀} may not consider any synthetic quantity contributions implying that synthetic quantity contributions are not considered at all for the creation of tolerable broker orders.

It is noted that independent of its quantity, the tolerable broker may always have priority over orders entered after cross announcement at t₀ on the same match price level because of the time slicing approach outlined in the third cross matching rule. Consequently, a match price level containing a tolerable broker order and only accumulated quantities entered after t₀, i.e. accQₘₖₜ^{<t}^{₀}+accQₗᵢₘ^{<t}^{₀}=0 but accQₘₖₜ^{t}^{₁}^{-t}^{₀}+accQₗᵢₘ^{t}^{₁}^{-t}^{₀}>0, then the tolerable broker order may always be considered first for execution against the client order independent of the allocation scheme applied for the corresponding product.

As an example regarding the creation of tolerable broker orders, assume a market situation of FIGS. 8 and 9 with a first cross matching step which does not involve the broker order with its original broker price P_{Br}.

Additionally assume that in case of a buy client order, the maximum tolerable sell broker price P_{MinTol}^{sell} is equal to or below the best ask price APₜ_{₁} available on the broker side of the order book and that the sell broker price P_{Br}^{sell} is above this best price level, i.e. the relation

P_{MinTol}^{sell}≤APₜ_{₁}<P_{Br}^{sell}=P_{Cl}^{buy}

holds. Then, the best ask price level APₜ¹ is the first valid tolerable price level generating a tolerable sell broker order with price APₜ_{₁} joining the best ask price level of APₜ_{₁}.

In case of a sell client order, it may be assumed additionally that the maximum tolerable sell broker price P_{MaxTol}^{buy}, is equal to or above the best bid price BPₜ_{₁} available on the broker side of the order book and that the buy broker price P_{Br}^{buy} is below this best price level, i.e. the relation

P_{Cl}^{sell}=P_{Br}^{buy}<BPₜ_{₁}≤P_{MaxTol}^{buy}

holds. Thus, the best bid price level BPₜ_{₁} is the first valid tolerable price level generating a tolerable buy broker order with price BPₜ_{₁} joining the best bid price level of BPₜ_{₁}.

The tolerable broker quantity Q_{tolBr} of a tolerable broker order with order price P_{tolBr} may be calculated in two steps in an embodiment. In the first step, the accumulated quantity provided during the cross exposure period may be multiplied by a percentage value denoted by the tolerable quantity percentage tolQtyPcnt, i.e.

Q_{tolBr}^{pre}(P_{tolBr})=(accQₘₖₜ^{t}^{₁}^{-t}^{₀}(P_{tolBr})+accQₗᵢₘ^{t}^{₁}^{-t}^{₀}(P_{tolBr}))*tolQtyPcnt

where Q_{tolBr}^{pre} is indicating the preliminary tolerable broker quantity calculated in the first step to derive the tolerable broker quantity Q_{tolBr}.

In a second step, it may be verified that the tolerable broker quantity does not exceed the maximum tolerable broker quantity limit Q_{tolBr}^{max} which is determined as a percentage value of the remaining client order quantity Q_{Cl}^{max} available at the matching price level P_{tolBr}, i.e.

Q_{tolBr}^{max}(P_{tolBr})=Q_{Cl}^{rem}(P_{tolBr})*tolQtyMaxPcnt

where tolQtyMaxPcnt denotes the tolerable quantity limit percentage. The restriction to a maximum tolerable broker quantity limit Q_{tolBr}^{max} may be required to prevent that the broker receives a too large share of the client order at a price level he initially did not consider. The quantity restriction may also be regarded as a protection for the broker. The maximum tolerable broker quantity Q_{tolBr}^{max} is set to zero implying that the tolerable broker order may be cancelled at the corresponding price level in case the preliminary tolerable broker quantity Q_{tolBr}^{pre} is below a percentage value of the remaining client order quantity Q_{Cl}^{rem} available at the matching price level P_{tolBr}, i.e. if Q_{tolBr}^{pre}(P_{tolBr})<Q_{Cl}^{rem}(P_{tolBr})*tolQtyMinPcnt then Q_{tolBr}^{max}=0.

The parameters tolerable quantity percentage tolQtyPcnt, the tolerable quantity maximum percentage tolQtyMaxPcnt and tolerable quantity minimum percentage tolQtyMinPcnt are determined by the exchange in case the broker entering the cross request is not allowed to specify the tolerable broker quantity percentage tolBrOrderQtyPcnt. In case the tolerable broker quantity percentage is allowed to be provided by the broker entering the cross request, then the tolerable quantity minimum percentage is set to zero, i.e. tolQtyMinPcnt=0, and the tolerable quantity maximum percentage is set identical to the tolerable broker quantity percentage, i.e. tolQtyMaxPcnt=tolBrOrderQtyPcnt, and the tolerable quantity percentage is calculated as follows:

$$tolQtyPcnt = \frac{tolBrOrderQtyPcnt}{( 1 - tolBrOrderQtyPcnt )}$$

Finally, the tolerable broker quantity Q_{tolBr} of a tolerable broker order with price P_{tolBr} may be given by

Q_{tolBr}=MIN {Q_{tolBr}^{pre},Q_{tolBr}^{max},Q_{remBr}⁽ⁿ⁾}

where Q_{remBr}⁽ⁿ⁾ denotes the remaining quantity on the broker side available for the n-th match step of a cross matching event. Note that the remaining broker quantity of the current match step Qᵣₑₘ⁽ⁿ⁾ may be given by the remaining broker quantity of the previous match step Qᵣₑₘ⁽ⁿ⁻¹⁾ minus the matched broker quantity of the previous match step denoted by Q_{tolBr}^{match}, i.e. Q_{remBr}⁽ⁿ⁾=Q_{remBr}⁽ⁿ⁻¹⁾−Q_{tolBr}^{match} for n=2, . . . , n₀ and with starting point Q_{remBr}⁽¹⁾=Q_{Br} for n=1 as first match step.

The remaining broker quantity Q_{remBr}⁽ⁿ⁾ for n=1, . . . , n₀ is indicating that the broker side can be involved in more than one match price level. Thus, the creation of a tolerable broker order may occur several times on different match price levels MP⁽ⁿ⁾ with n=1, . . . , n₀ in a cross match event. As already mentioned, this can only occur for market situations described in FIGS. 8 and 9.

### Further Examples

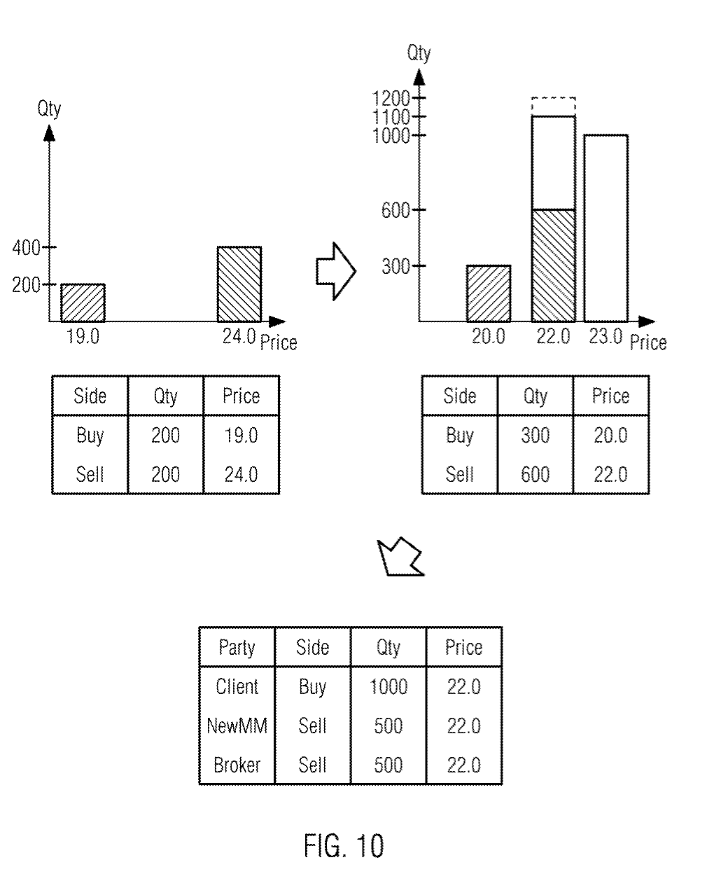

As a precondition, assume
a market situation described in FIG. 10 with BPₜ_{₀}≤BPₜ_{₁}<APₜ_{₁}<P_{Br}^{sell}≤APₜ_{₀} having BPₜ_{₁}=20.0, APₜ_{₁}=22.0 and APₜ_{₀}=24.0.
a cross request with a client buy order having a client quantity of Q_{Cl}=1000 and a client price of P_{Cl}^{buy}=23.0. Then, the broker side is the sell side with a sell broker quantity of Q_{Br}=Q_{Cl}=1000 and a sell broker price of P_{Br}^{sell}=P_{Cl}^{buy}=23.0. Additionally, the entering broker is specifying a minimum tolerable sell broker price of P_{MinTol}^{sell}=22.0.
a tolerable quantity percentage of tolQtyPcnt=100% and a tolerable quantity limit percentage of tolQtyLimPcnt=50%.

FIG. 10 illustrates an example where a market maker is entering a sell order of 600@22.0. Since the relation P_{MinTol}^{sell}≤APₜ¹<P_{Br}^{sell} (i.e. 22.0≤22.0<23.0) holds, the first match price in the cross match even is given by MP⁽¹⁾=APₜ_{₁}=22.0. This match price is also a valid tolerable sell broker price, i.e. MP⁽¹⁾=APₜ_{₁}=P_{tolBr}^{sell}=22.0. The tolerable broker quantity Q_{tolBr} is calculated by

Q_{tolBr}=MIN {Q_{tolBr}^{pre},Q_{tolBr}^{max},Q_{remBr}⁽¹⁾}=MIN {600,5001000}=500,

where the preliminary tolerable broker quantity Q_{tolBr}^{pre} is calculated by

Q_{tolBr}^{pre}=(accQₘₖₜ^{t}^{₁}^{-t}^{₀}+accQₗᵢₘ^{t}^{₁}^{-t}^{₀})*tolQtyPcnt=600*100%=600,

the maximum tolerable broker quantity Q_{tolBr}^{max} is given by

Q_{tolBr}^{max}=Q_{Cl}*tolQtyLimPcnt=1000*50%=500

and the remaining broker quantity of the first match step Q_{remBr}⁽¹⁾ is identical to

Q_{remBr}⁽¹⁾=Q_{Br}=1000.

To summarize, the first match step with a match price level of MP⁽¹⁾=22.0 has on the broker side 500 lots of tolerable broker quantity and 600 lots of market maker quantity which are now executed in a cross matching event against a client order with 1000 lots. Because of the time slicing approach, the broker quantity always has higher priority than the market maker quantity regardless of the allocation scheme applied for the corresponding product. Therefore, the 500 lots of the broker is completely matched against the client order before the market maker quantity is considered. Since the tolerable quantity percentage is chosen to be tolQtyPcnt=100% and the tolerable quantity limit percentage is chosen to be tolQtyLimPcnt=50%, it is ensured that the broker will receive 50% (i.e. 500 lots) of the matched client order quantity at match price level 22.0. This is also valid in case the market maker is providing 50% of the client order or more (i.e. equal to or more than 500 lots) at the same match price level. However, the market maker will receive not more than 500 lots regardless of the size of his sell order provided it exceed 500 lots. The cross matching is concluded after the first match step at a better price of MP⁽¹⁾=22.0 from the client point of view since the client order quantity is completely consumed in this first match step.

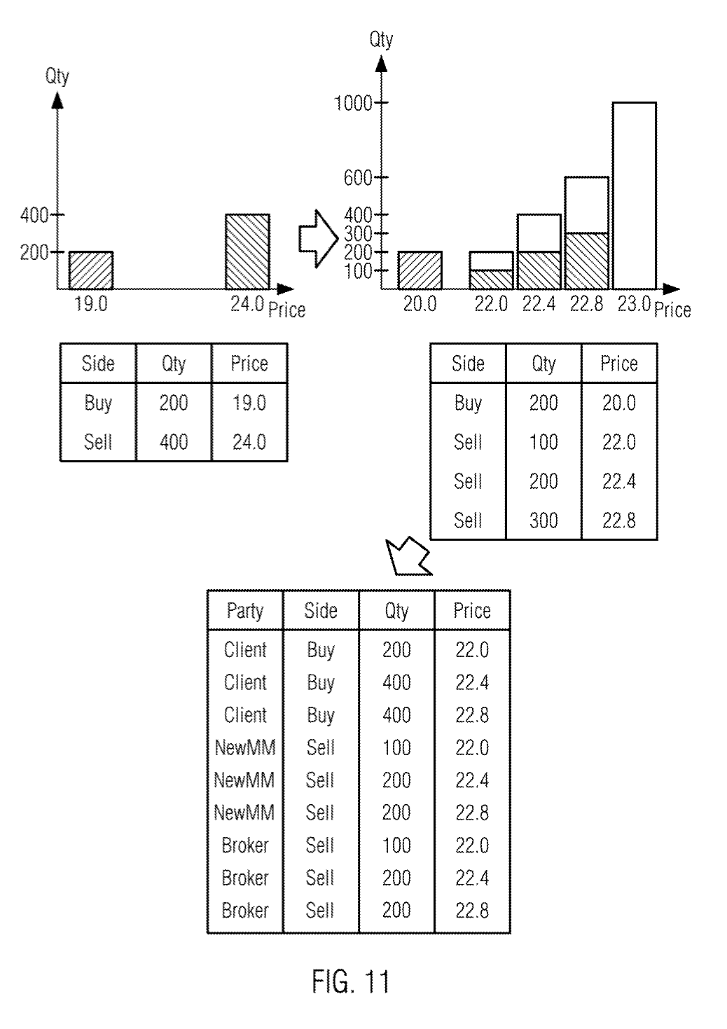

FIG. 11 illustrates an example where a market maker is entering the sell orders 100@22.0, 200 @22.4 and 300@22.8. Since the market maker prices are all valid tolerable broker prices, the first match step is executed at MP⁽¹⁾=22.0 with

Q_{tolBr}=MIN {Q_{tolBr}^{pre},Q_{tolBr}^{max},Q_{remBr}⁽¹⁾}=MIN {100, 500, 1000}=100.

Thus, the first match step is concluded with MQ⁽¹⁾=200 with 100 lots from the tolerable sell broker order and 100 lots from the market maker sell order. The second match step is executed at MP⁽²⁾=22.4 with

Q_{tolBr}=MIN {Q_{tolBr}^{pre},Q_{tolBr}^{max},Q_{remBr}⁽²⁾}=MIN {200, 400, 900}=200.

Thus, the second match step is concluded with MQ⁽²⁾=400 with 200 lots from the tolerable sell broker order and 200 lots from the market maker sell order. The third match step is executed at MP⁽³⁾=22.8 with

Q_{tolBr}=MIN {Q_{tolBr}^{pre},Q_{tolBr}^{max},Q_{remBr}⁽³⁾}=MIN {300, 200, 700}=200.

Thus, the third and final match step is concluded with MQ⁽¹⁾=400 with 200 lots from the tolerable sell broker order and 200 lots from the market maker sell order. Note that the slicing approach ensured that the tolerable broker order is served first before the order of the market maker entered after to is considered.

In total, the broker received from the original 1000 lots of the client order in the first example 500 lots at a match price of 22.0 and in the second example in total 500 lots at an averaged match price of 22.48. Since the market maker quotes in the second example were less aggressive, the market maker received less quantities than the broker but the broker received—from his point of view—a better price in the second example.

The client order received the 1000 lots in the first example at a match price of 22.0 and in the second example at an averaged match price of 22.48 which is a result of the less aggressive quoting of the market maker in the second example. From a client point of view, both match prices are better than the original buy price of 23.00.

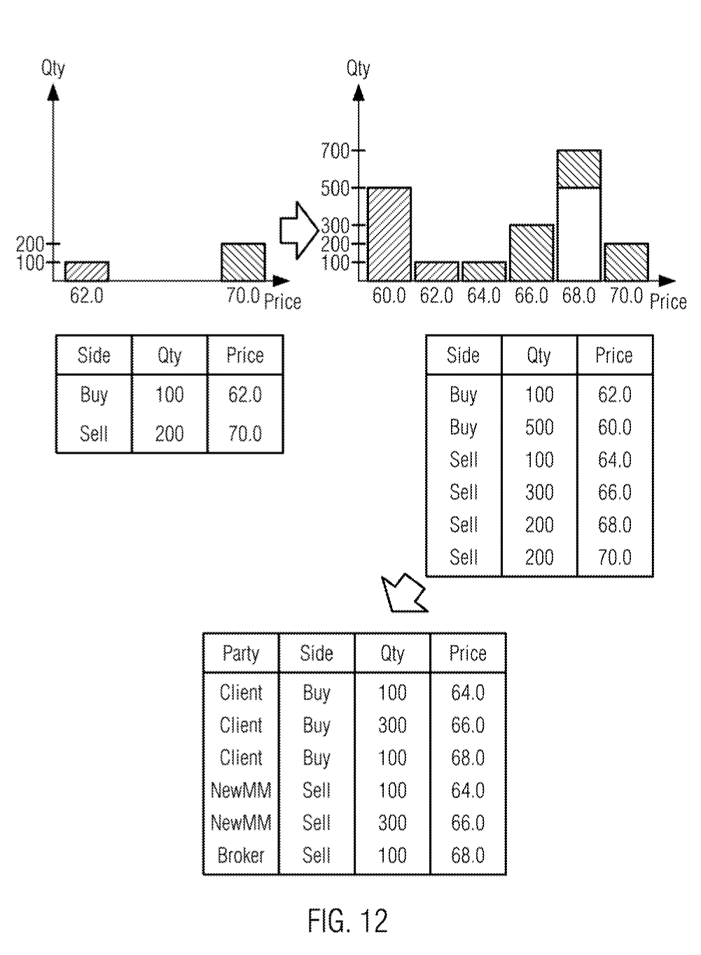

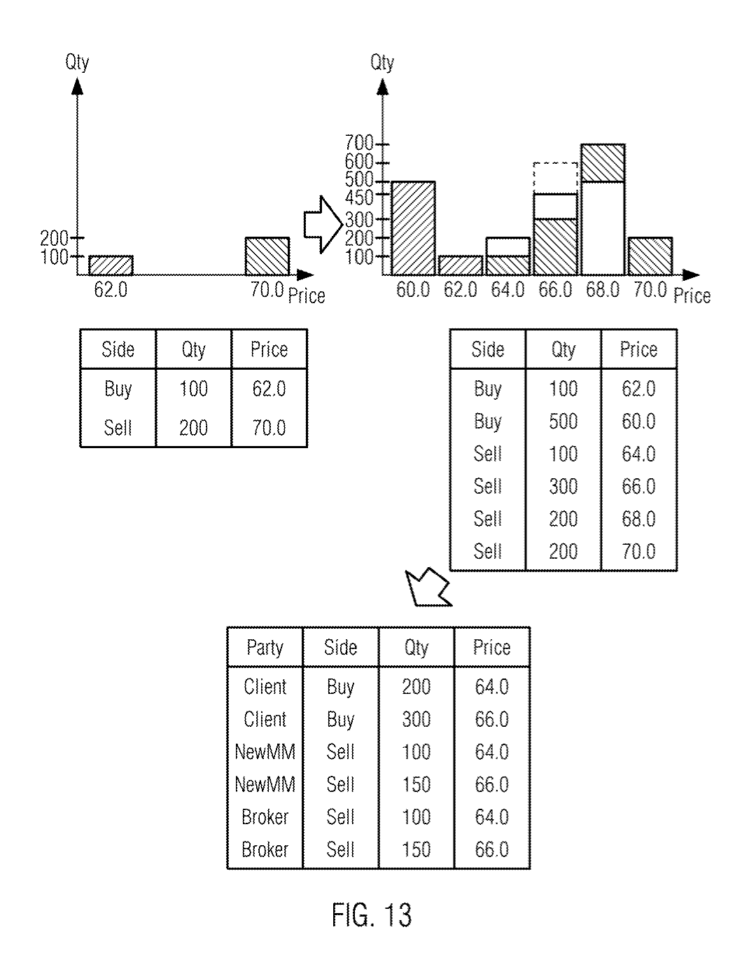

FIGS. 12 and 13 illustrate similar examples without (FIG. 12) and with (FIG. 13) using a tolerable price. In these examples, a client order is an order to by 500 lots at a price of 68. As can be seen, when not using a tolerable price, only 20% of the client order is executed against the broker order, and the remaining 80% are executed against market makers. According to FIG. 13, when using a tolerable price of 64.0, 50% of the client order is executed against the broker order.

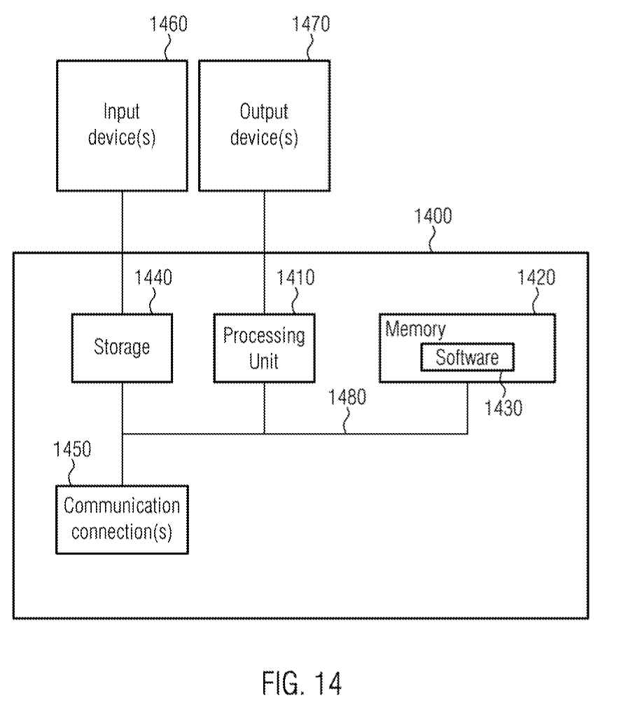

Referring now to FIG. 14, the above embodiments may be implemented using one or more of the computer systems or computer environments as shown in this figure.

The computing environment 1400 includes at least one processing unit 1410 and memory 1420. The processing unit 1410 executes computer-executable instructions and can be a real or a virtual processor. In a multi-processing system, multiple processing units execute computer-executable instructions to increase processing power. The memory 1420 can be volatile memory (e.g., registers, cache, RAM), non-volatile memory (e.g., ROM, EEPROM, flash memory, etc.), or some combination of the two. The memory 1420 can store software 1430 implementing described techniques, and other data. In particular, the memory can store the order book 100 and its elements 110-140

A computing environment can have additional features. For example, the computing environment 1400 includes storage 1440, one or more input devices 1460, one or more output devices 1470, and one or more communication connections 1480. An interconnection mechanism 1480, such as a bus, controller, or network interconnects the components of the computing environment 1400. Typically, operating system software or firmware (not shown) provides an operating environment for other software executing in the computing environment 1400, and coordinates activities of the components of the computing environment 1400.

The storage 1440 can be removable or non-removable, and includes magnetic disks, magnetic tapes or cassettes, CD-ROMs, CD-RWs, DVDs, or any other medium which can be used to store information and which can be accessed within the computing environment 1400. The storage 1440 can store instructions for the software 1430.

The input device(s) 1460 can be a touch input device such as a keyboard, mouse, pen, trackball, touch screen, or game controller, a voice input device, a scanning device, a digital camera, remote control, or another device that provides input to the computing environment 1400. The output device(s) 1470 can be a display, television, monitor, printer, speaker, or another device that provides output from the computing environment 1400.

The communication connection(s) 1480 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1400, computer-readable media include memory 1420, storage 1440, communication media, and combinations of any of the above.

Of course, FIG. 14 illustrates computing environment 1400, display device 1470, and input device 1460 as separate devices for ease of identification only. Computing environment 1400, display device 1470, and input device 1460 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1400 can be a set-top box, personal computer, or one or more servers, for example a farm of networked servers, a clustered server environment, or a cloud network of computing devices.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. A computer system comprising a memory and one or more processors, the memory storing executable instructions that, when being executed by the one or more processors, cause the one or more processors to:
receive a cross request from a first market participant in a single transaction, the cross request including data specifying a client order and indicating a predefined cross match type, the cross request being a request to enter a cross event of said predefined cross match type into an order book and perform a cross match of said client order in accordance with said predefined cross match type;
receive orders and/or quotes from one or more second market participants different from said first market participant, said orders and/or quotes being received within a predetermined period of time; and
perform the cross match in accordance with said predefined cross match type in the order book immediately after expiration of said predetermined period of time, wherein performing the cross match in accordance with said predefined cross match type comprises matching the client order against an order of the first market participant and zero or more of the orders or quotes received from the one or more second market participants, the order of the first market participant being generated as an opposite order to the client order and having a higher priority than any orders or quotes received from the one or more second market participants within said predetermined period of time that are of the same price level than the order of the first market participant.

2. The computer system of claim 1, wherein the memory further comprises instructions to:
send a cross announcement to said second market participants after having received said cross request,
wherein said predetermined period of time starts on or immediately after sending said cross announcement.

3. The computer system of claim 2, wherein said predetermined period of time has a predefined or randomly defined time length.

4. The computer system of claim 2, wherein said order of the first market participant is generated to have an order priority time set to one of the time of sending said cross announcement or the start time of said predetermined period of time.

5. The computer system of claim 4, wherein performing the cross match in accordance with said predefined cross match type further comprises matching the client order against one or more orders or quotes of arbitrary market participants having an order priority time earlier than the order priority time of the first market participant, wherein said one or more orders or quotes of said arbitrary market participants have a higher priority than the order of the first market participant.

6. The computer system of claim 2, wherein the cross request further includes data specifying a maximum tolerable price that is different from a price of the client order, wherein more than one order of the first market participant is generated, each of said more than one order of the first market participant having a price in a range given by the price of the client order and said maximum tolerable price, each price of said more than one order of the first market participant corresponding to a price of one of said orders or quotes received from said one or more second market participants after said cross announcement was sent out.

7. The computer system of claim 6, wherein each of said more than one order of the first market participant is generated to have a quantity derived from one or more of:
the accumulated quantities of the orders and quotes having the same price received from said one or more second market participants after said cross announcement was sent out;
a maximum quantity percentage of the remaining client order quantity available for matching against said more than one order of the first market participant; and
a minimum quantity percentage of the remaining client order quantity available for matching against said more than one order of the first market participant.

8. The computer system of claim 1, wherein performing the cross match in accordance with said predefined cross match type is configured to consider the client order as the only order on the order book side of the client order.

9. A method of operating a computer system to initiate a cross match in an order book, comprising:
receiving a client order;
generating a cross request including data specifying the client order and data specifying attributes of an opposite order to the client order, the cross request further indicating a predefined cross match type, the cross request being a request to enter a cross event of said predefined cross match type into the order book to perform a cross match of said client order against said opposite order and at least one order and/or quote from one or more other market participants; and
performing a single transaction based on the generated cross request to cause the cross event to be entered into the order book.

10. The method of claim 9, wherein said at least one order and/or quote from said one or more other market participants are orders and quotes entered into the order book during an announcement period after said single transaction took place.

11. The method of claim 10, wherein said announcement period has a predefined or randomly defined time length.

12. The method of claim 10, wherein said opposite order has an order priority time set to one of the time of performing said single transaction or the start time of said announcement period.

13. The method of claim 12, wherein performing the cross match in accordance with said predefined cross match type comprises matching the client order against none, one or more orders or quotes of any market participants having an order priority time earlier than the order priority time of the opposite order.

14. The method of claim 9, wherein the data specifying attributes of the opposite order includes data specifying a maximum tolerable price that is different from a price of the client order thereby specifying a price range given by the price of the client order and said maximum tolerable price.

15. The method of claim 14, wherein the data specifying attributes of the opposite order further includes data specifying a method of how an opposite order's quantity is to be considered at the tolerable price.

16. The method of claim 15, wherein said method of how the opposite order's quantity is to be considered at the tolerable price is parameterized by one or more of a percentage parameter indicating the opposite order's quantity in proportion to accumulated quantities of the orders and quotes at a given price level entered after a cross announcement, a maximum quantity percentage of the remaining client order quantity available for matching at said price level against said opposite order, and a minimum quantity percentage of the remaining client order quantity available for matching at said price level against said opposite order.

17. The method of claim 9, wherein said predefined cross match type is a type of cross match that considers the client order as the only order on the order book side.

18. A tangible non-transitory computer-readable storage medium storing a data structure holding an order book, said data structure comprising:
data indicating a cross event of a predefined cross match type for a client order received from a first market participant;
data specifying the client order;
data specifying orders and/or quotes received from one or more second market participants different from said first market participant, said orders and/or quotes being received within a predetermined period of time; and
data specifying an opposite order to the client order, the opposite order having a higher priority than any orders or quotes received from the one or more second market participants within said predetermined period of time that are of the same price level than the opposite order.

19. The tangible non-transitory computer-readable storage medium of claim 18, wherein the data structure further comprises:
computer-executable instructions to perform a cross match in accordance with said predefined cross match type immediately after expiration of said predetermined period of time, wherein performing the cross match in accordance with said predefined cross match type comprises generating said data specifying said opposite order, and matching the client order against said opposite order and one or more of the orders or quotes received from the one or more second market participants.

20. The tangible non-transitory computer-readable storage medium of claim 18, wherein the data structure further comprises:
computer-executable instructions to send a cross announcement to said second market participants after having received a cross request that included data specifying said client order and indicating said predefined cross match type.
